(19) United States
(12) Patent Application Publication
(10) Pub. No.: US 2026/0148290 A1
(43) Pub. Date: May 28, 2026

(54) SYSTEMS AND METHODS FOR AUTOMATICALLY UPDATING A DIGITAL APPLICATION

(71) Applicant: The PNC Financial Services Group, Inc., Pittsburgh, PA (US)

(72) Inventors: Satyan Nagaraj AVATARA, Landenberg, PA (US); Lakhbir Singh LAMBA, Gibsonia, PA (US); Anil Cherian JACOB, Mickleton, NJ (US); Kaleeswar BABURAJ, Apex, NC (US); Christian Paul SIRNEY, Pittsburgh, PA (US); Rajesh RAMAN, Sewickley, PA (US); Rachana BHATT, Media, PA (US)

(73) Assignee: The PNC Financial Services Group, Inc., Pittsburgh, PA (US)

(21) Appl. No.: 19/408,339

(22) Filed: Dec. 3, 2025

Related U.S. Application Data
(62) Division of application No. 18/675,762, filed on May 28, 2024.
(60) Provisional application No. 63/616,406, filed on Dec. 29, 2023.

(51) Int. Cl. G06Q 40/02; G06Q 20/34; G06Q 30/0207; G06Q 40/03; H04L 67/306

(52) U.S. Cl. CPC G06Q 40/02; G06Q 20/341; G06Q 30/0207; G06Q 40/03; H04L 67/306

(57) ABSTRACT

A system is disclosed for automatically updating a digital application using a machine learning algorithm. In some embodiments, the system includes a memory and a processer configured to execute instructions to display and update one or more secondary applications, which include at least one user input option, on a home page of the digital application. In some embodiments, the machine learning algorithm is trained using customer data, user interactions, and historical data to create and update a user profile. In some embodiments, the processor, using the machine learning algorithm, updates the one or more user input options for each of the secondary applications and assigns a score to each updated user input option. In some embodiments, the user profile is updated based on the scores and is continuously monitored, using the machine learning algorithm, to determine whether further updates to the at least one user input option are necessary.

### BACKGROUND

Digital applications are often designed perform tasks with the goal of making a user's life more convenient. Yet, digital applications often lack features that would allow the user to personalize or customize the digital application to fit the user's needs. If a user wants to maximize the utility of a given digital application, some personalization and customization of digital application features is necessary.

Even when a digital application offers personalization or customization features, a user may be unaware of those features, may not know how to change the features, or may simply be too lazy to change the features. Because personalization and customization features are often underutilized or not utilized at all, users often fail to maximize the utility of digital applications.

Artificial Intelligence (AI) models, including machine learning algorithms, can be used to automatically personalize or customize digital applications. By identifying patterns in user digital application use and combining those patterns with training data, AI models can personalize or customize digital applications to maximize digital application utility for users. Digital application personalization or customization can be done automatically or with user approval.

The disclosed system and methods describe how AI models, including machine learning algorithms, can be used to personalize, customize, or automatically update digital applications. By using AI to personalize, customize, or update digital applications, users can maximize digital application utility and get the most out of digital application features.

### SUMMARY

In an embodiment described herein, a system for automatically updating a home page of a digital application using a machine learning algorithm is disclosed. The system may include at least one memory for storing instructions and at least one processor in communication with the at least one memory. The at least one processor may be configured to execute the stored instructions to display a plurality of secondary applications hosted on the home page of the digital application. Each of the plurality of secondary applications may include at least one user input option. The at least one processor may be further configured to generate a user profile based on a set of user interactions with the at least one user input option and a set of historical information. The processor may, after generating the user profile, continuously monitor the digital application and update the user profile based on the set of user interactions with the plurality of user input options and the set of historical information. The processor may be configured to generate, utilizing the machine learning algorithm, at least one updated user input option for each of the plurality of secondary applications based on the user profile and display the at least one updated user input option for each of the plurality of secondary applications. After generating and displaying the at least one updated user input option, the processor may assign, using the machine learning algorithm, a score to each of the at least one updated user input option for each of the plurality of secondary applications. The score may be determined based on whether the user interacts with one or more of the at least one updated user input option for each of the plurality of secondary applications. The processor may be configured to update, using the machine learning algorithm, the user profile based on the scores. After updating the user profile based on the scores, the processor may be configured to continuously monitor the user profile using the machine learning algorithm, to determine whether a further update to the updated at least one user input option is necessary based on changes to the user profile.

According to some embodiments, the plurality of secondary applications may include at least one of a quick actions application, an account summary application, a recent transactions application, a shopping offers application, a personal offers application, a financial health application, a payments application, a family share application, and a loans and credit cards application.

According to some embodiments, the quick actions application may further include a check deposit option, a send money option, an ATM locator option, and a pay balance option.

According to some embodiments, the family share application may further include an option to control monthly allowances of a family share member, an option to set transaction limits for the family share member, an option to set card controls for the family share member, and an option to set payment due dates for the family share member.

According to some embodiments, the historical information may further include a set of location-based information for transactions, and the machine learning algorithm may use the set of location-based information for transactions to generate a location-based rewards offer.

According to some embodiments, the historical information may further include a set of time-based information for transactions, and the machine learning algorithm may use the set of time-based information for transactions to generate a time-based rewards offer.

According to some embodiments, the historical information may further include a set of product-based information for transactions, and the machine learning algorithm may use the set of product-based information for transactions to generate a product-based rewards offer.

According to some embodiments, the loans and credit cards application may further include a set of information related to a user vehicle, and the machine learning algorithm may use the set of information related to the user vehicle to present a set of vehicle-related offers.

According to some embodiments, the set of vehicle-related offers may include at least one of an insurance partner offer, a vehicle maintenance offer, a vehicle parts offer, and a vehicle loan refinancing offer.

According to some embodiments, the set of vehicle-related offers may include a notification to renew a vehicle registration.

According to some embodiments, the set of vehicle-related offers may include a notification to service the user vehicle.

In an embodiment described herein, a system for automatically updating account preferences in a digital application using a machine learning algorithm is disclosed. The system may include at least one memory for storing instructions and at least one processor in communication with the at least one memory. The at least one processor may be configured to execute the stored instructions to generate a financial literacy score. The financial literacy score may be determined by a first number of courses completed, a second number of games completed, and a third number of activities completed. The processor may be further configured to associate a user profile with the financial literacy score. The processor may be further configured to input the first number of courses completed, the second number of games completed, and the third number of activities completed into the machine learning algorithm. The processor may be configured to determine, utilizing the machine learning algorithm, whether a set of account preferences should be adjusted. The set of account preferences may comprise a spending limit, a payment due date, and a set of card controls. The processor may be configured to, based on the determination by the machine learning algorithm, adjust the set of account preferences to increase or decrease the spending limit, extend or shorten the payment due date, or activate or disable one or more card controls of the set of card controls.

According to some embodiments, the user profile may further include a spending history.

According to some embodiments, the spending history may further include a set of location-based information for transactions, and the machine learning algorithm uses the set of location-based information for transactions to generate a location-based rewards offer.

According to some embodiments, the spending history may further include a set of time-based information for transactions, and the machine learning algorithm may use the set of time-based information for transactions to generate a time-based rewards offer.

According to some embodiments, the spending history may further include a set of product-based information for transactions, and the machine learning algorithm may use the set of product-based information for transactions to generate a product-based rewards offer.

In an embodiment disclosed herein, a system for integrating third party application data into a digital application is disclosed. The system may include at least one memory for storing instructions and at least one processor in communication with the at least one memory. The at least one processor may be configured to execute the stored instructions to display a plurality of micro-applications hosted on a home page of the digital application. Each of the plurality of micro-applications may comprise a front-end interface that receives and displays information. The front-end interface may comprise a graphical user interface. The graphical user interface may receive information from a user and display information to the user. The at least one processor may be further configured to send a set of third-party hosted application information to the digital application through a set of application programming interfaces and convert the set of third-party hosted application information, using the set of application programming interfaces, into information suitable for display in the digital application.

In an embodiment disclosed herein, a system for automatically updating account preferences in a digital application using a machine learning algorithm is disclosed. The system may include at least one memory for storing instructions and at least one processor in communication with the at least one memory. The at least one processor may be configured to execute the stored instructions to generate, based on a set of user inputs, a set of card control preferences. The set of card control preferences may include a set of location-based controls, a set of threshold amount controls, a set of merchant type controls, and a set of transaction type controls. The processor may be further configured to associate a user profile with the set of card control preferences and input a transaction history into the machine learning algorithm. The transaction history may include geolocation information, card use information, and merchant information. The at least one processor may be further configured to determine, using the machine learning algorithm, if the set of card control preferences should be adjusted based on the transaction history and automatically adjust the set of card control preferences based on the determination.

According to some embodiments, the machine learning algorithm may use the geolocation information to generate an in-store rewards offer.

According to some embodiments, the machine learning algorithm may use the geolocation information to generate a location-specific rewards offer.

According to some embodiments, the machine learning algorithm may use the merchant information to generate a merchant-specific rewards offer.

According to some embodiments, the set of card control preferences may further include a credit card-lock.

According to some embodiments, the credit card-lock may lock a physical credit card.

According to some embodiments, the credit card-lock may lock a virtual credit card.

In an embodiment described herein, a system for automatically generating offers in a digital application using a machine learning algorithm is disclosed. The system may include at least one memory for storing instructions and at least one processor in communication with the at least one memory. The at least one processor may be configured to execute the stored instructions to associate a user account with a user. The user account may include a set of vehicle information. The set of vehicle information may include at least one of a set of mileage information, a loan balance, a vehicle value, a vehicle age, a vehicle make, a vehicle model, a vehicle year, a set of vehicle location information, and a loan term. The processor may be further configured to input the set of vehicle information into the machine learning algorithm and determine, utilizing the machine learning algorithm, a set of offers for the user based on the set of vehicle information. The set of offers may include at least one of one or more vehicle maintenance offers chosen from a set of vehicle maintenance offers, one or more vehicle insurance offers chosen from a set of vehicle insurance offers, one or more vehicle refinance offers chosen from a set of vehicle refinance offers, and one or more offers from a set of offers based on vehicle location. The at least one processor may be further configured to present the set of offers on a display of the user device.

According to some embodiments the vehicle maintenance offer may be based on the set of mileage information.

According to some embodiments, the vehicle insurance offer may be based on the vehicle type and a user credit score.

According to some embodiments, the machine learning algorithm may generate a pricing model based, at least in part, on a user credit score.

According to some embodiments, the machine learning algorithm may use the set of vehicle location information to generate a location heat map.

According to some embodiments, the machine learning algorithm may use the set of vehicle information to generate a vehicle loan to vehicle value ratio.

In an embodiment described herein, a system for automatically generating portals to one or more third-party applications using a machine learning algorithm is disclosed. The system may include at least one memory for storing instructions and at least one processor in communication with the at least one memory. The at least one processor may be configured to execute the stored instructions to associate a user account with a user. The user account may include a set of payment information. The set of payment information may automatically update when a new transaction occurs. The at least one processor may be further configured to input the set of payment information into the machine learning algorithm and determine, using the machine learning algorithm, a set of preferred service providers and a set of preferred sellers based on the set of payment information. The at least one processor may be further configured to generate a set of portals to the set of preferred service providers and the set of preferred sellers. The at least one processor may be configured to present the set of portals on the display of a mobile device, receive a selection of one of the set of portals, and automatically redirect the user to the third-party application corresponding to a preferred service provider within the set of preferred service providers or a preferred seller within the set of preferred sellers. The set of portals may automatically redirect the user to the third-party application corresponding to a preferred service provider within the set of preferred service providers or a preferred seller within the set of preferred sellers.

According to some embodiments, the set of portals may enable payment via a buy now pay later feature within the digital application.

### BRIEF DESCRIPTION OF FIGURES

FIG. 1 is an illustration of one or more goals of a personalized banking application in accordance with some embodiments of the present disclosure.

FIG. 2 is a flowchart illustrating how a system updates a personalized banking application in accordance with some embodiments of the present disclosure.

FIG. 3A is a schematic diagram illustrating a machine learning algorithm updating a digital application in accordance with some embodiments of the present disclosure.

FIG. 3B is a schematic diagram illustrating a machine learning algorithm personalizing a digital application in accordance with some embodiments of the present disclosure.

FIG. 4 is a schematic diagram illustrating data inputs used to update a user profile using a machine learning algorithm in accordance with some embodiments of the present disclosure.

FIG. 5 is a schematic diagram illustrating a system for updating a user profile in accordance with some embodiments of the present disclosure.

FIG. 6 is a flowchart illustrating a system for updating account preferences of a digital application in accordance with some embodiments of the present disclosure.

FIG. 7 illustrates an example of a home page of a personalized banking application in accordance with some embodiments of the present disclosure.

FIG. 8A illustrates an example of a vehicle loan feature of a personalized banking application in accordance with some embodiments of the present disclosure.

FIG. 8B illustrates an example of vehicle summary feature of a personalized banking application in accordance with some embodiments of the present disclosure.

FIG. 8C illustrates an example of a vehicle services feature and a vehicle dealers feature of a personalized banking application in accordance with some embodiments of the present disclosure.

FIG. 9A is an illustration of a send payments feature of a payments application and a buy now pay later feature of a personalized banking application in accordance with some embodiments of the present disclosure.

FIG. 9B is an illustration of a receive payments feature of the payments application and a bill payment feature of a personalized banking application in accordance with some embodiments of the present disclosure.

FIG. 9C is an illustration of a wallet feature and a pay to buy feature of a personalized banking application in accordance with some embodiments of the present disclosure.

FIG. 10A is an illustration of a credit cards shop of a personalized banking application in accordance with some embodiments of the present disclosure.

FIG. 10B is an illustration of a credit card application of a personalized banking application in accordance with some embodiments of the present disclosure.

FIG. 10C is an illustration of a credit card approval page and a credit card summary page of a personalized banking application in accordance with some embodiments of the present disclosure.

FIG. 10D is an illustration of a child user feature of a personalized banking application in accordance with some embodiments of the present disclosure.

FIG. 11 is an illustration of a financial literacy feature of a personalized banking application in accordance with some embodiments of the present disclosure.

FIG. 12A is an illustration of a card control feature and a third-party subscription management feature of a personalized banking application in accordance with some embodiments of the present disclosure.

FIG. 12B is an illustration of a third-party subscription management feature of a personalized banking application in accordance with some embodiments of the present disclosure.

FIG. 12C is an illustration of a transaction overview feature of a personalized banking application in accordance with some embodiments of the present disclosure.

FIG. 12D is an illustration of a transaction overview feature of a personalized banking application in accordance with some embodiments of the present disclosure.

FIG. 12E is an illustration of a credit card personalization feature in accordance with some embodiments of the present disclosure.

FIG. 13 is an illustration of a replace a card feature of a personalized banking application in accordance with some embodiments of the present disclosure.

FIG. 14A is an illustration of a dispute a transaction feature of a personalized banking application in accordance with some embodiments of the present disclosure.

FIG. 14B is an illustration of a track dispute feature of a personal banking application in accordance with some embodiments of the present disclosure.

FIG. 15A is an illustration of a report a problem feature of a personalized banking application in accordance with some embodiments of the present disclosure.

FIG. 15B is an illustration of a report a problem feature of a personalized banking application in accordance with some embodiments of the present disclosure.

FIG. 15C is an illustration of a report a problem feature of a personalized banking application in accordance with some embodiments of the present disclosure.

FIG. 15D is an illustration of a report a problem feature of a personalized banking application in accordance with some embodiments of the present disclosure.

FIG. 16 is an illustration of an easy lock feature in accordance with some embodiments of the present disclosure.

FIG. 17 is a schematic diagram of one embodiment of a system for automatically updating a home page of a digital application using a machine learning algorithm in accordance with some embodiments of the present disclosure.

FIG. 18 is a schematic diagram illustrating an example of data used by a machine learning algorithm to create a personalized user profile in accordance with some embodiments of the present disclosure.

FIG. 19 is a schematic diagram illustrating an example of machine learning algorithms used to create a personalized user profile in accordance with some embodiments of the present disclosure.

FIG. 20 is a schematic diagram of one embodiment of a system for automatically personalizing a user profile using a machine learning algorithm.

FIG. 21 is a schematic diagram illustrating types of customer data that may be inputs to a machine learning algorithm in some disclosed embodiments.

FIG. 22 is a flowchart illustrating how a personalized banking application is updated using a machine learning algorithm in accordance with some embodiments of the present disclosure.

FIG. 23 is a schematic diagram depicting a system for automatically updating account preferences in a digital application using a machine learning algorithm in accordance with some embodiments of the present disclosure.

FIG. 24 is a schematic diagram illustrating a system for integrating third party application data into a digital application in accordance with some embodiments of the present disclosure.

FIG. 25 is a schematic diagram illustrating a system for automatically updating account preferences in a digital application using a machine learning algorithm in accordance with some embodiments of the present disclosure.

FIG. 26 is a schematic diagram illustrating a system for automatically generating offers in a digital application using a machine learning algorithm in accordance with some embodiments of the present disclosure.

FIG. 27 is a schematic diagram illustrating a system for automatically generating portals to one or more third-party applications using a machine learning algorithm in accordance with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

Exemplary embodiments of a digital application and features of the digital application as described herein may be executed by computer hardware including a processor which may execute instructions stored on a memory. One or more machine learning algorithms may also be used in conjunction with the digital application to modify or personalize one or more features of the digital application. In a digital application, multiple features and sub-features can often be accessed via a home page. A user can access these features and sub-features by interacting with a user interface of a mobile device. A user interface may be an interface, such as a graphical user interface, that allows the user to provide inputs to and receive outputs from the digital application. In some digital applications, the home page and the features and sub-features displayed on the home page are set. In other digital applications, the user may be able to add or delete features and sub-features, but digital applications often lack the ability to personalize the application to each individual user. Digital banking applications for example, often contain information on the user's current banking information and allow a user to transfer money to and from the user's accounts and sometimes provide the user with generic offers but also lack personalization capabilities. As such, there is a need for a banking application that is personalized to the individual user.

The present disclosure relates to a system for automatically updating a digital application using a machine learning algorithm. In some embodiments, the digital application is a personal banking application.

In some embodiments the personalized banking application includes a home page. In various embodiments, the home page may include a plurality of secondary applications.

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

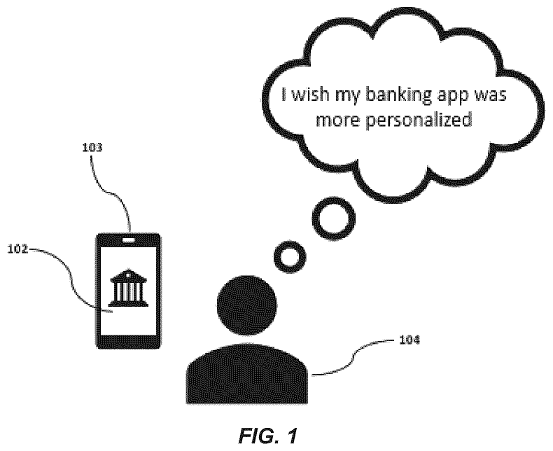

Reference will now be made in detail to the disclosed embodiments, examples of which are illustrated in the accompanying drawings. FIG. 1 is an illustration of one or more goals of a personalized banking application in accordance with some embodiments of the present disclosure. In some embodiments a user 104 may desire a banking application 102 that is personalized. In some embodiments, the banking application 102 may run on a mobile device 103.

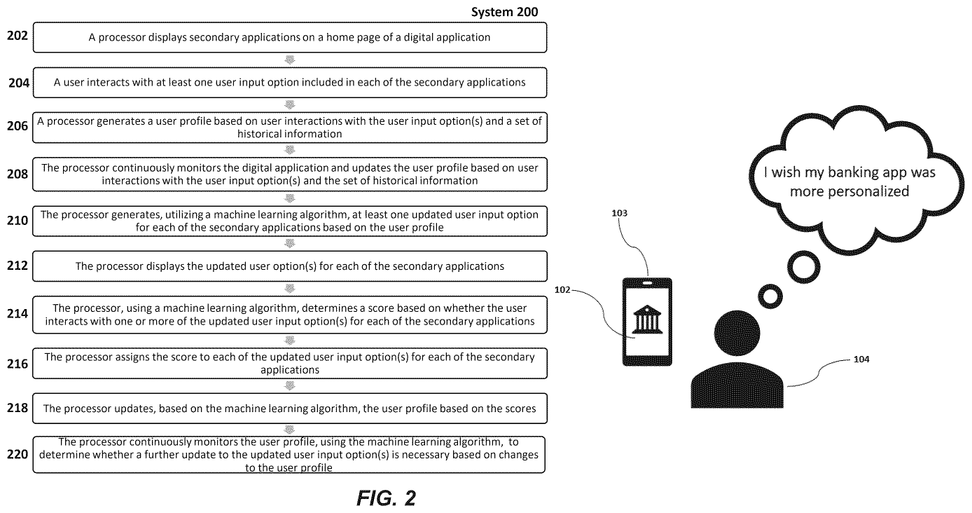

FIG. 2 is a flowchart illustrating how a system 200 personalizes and updates the banking application 102 in accordance with some embodiments of the present disclosure. In some embodiments, the system 200 initiates a step 202 where a processor displays secondary applications on a home page of a digital application as described herein. In some embodiments, the home page is displayed on a mobile device. In some embodiments, the system 200 includes a step 204 where a user interacts with at least one user input option, as described herein, included in each of the secondary applications. In some embodiments, the system 200 includes a step 206 where a processor generates a user profile based on user interactions with the user input option(s) and a set of historical information as described herein.

In some embodiments, the system 200 includes a step 208 where the processor continuously monitors the banking application and updates the user profile based on the user interactions with the user input option(s) and the set of historical information, as described herein. In some embodiments, the system 200 includes a step 210 where the processor generates, utilizing a machine learning algorithm, at least one updated user input option for each of the secondary applications based on the user profile as described herein.

In some embodiments, the system 200 includes a step 212 where the processor displays the updated user option(s) for each of the secondary applications, as described herein. In some embodiments, the system 200 includes a step 214 where the processor, using a machine learning algorithm, determines a score based on whether the user interacts with one or more of the updated user input option(s) for each of the secondary applications, as described herein. In some embodiments, the system 200 includes a step 216 where a processor assigns the score to each of the updated user input option(s) for each of the secondary applications, as described herein. In some embodiments, the system 200 includes a step 218 where the processor updates, based on the machine learning algorithm, the user profile based on the scores, as described herein. In some embodiments, the system 200 includes a step 220 where the processor continuously monitors the user profile, using the machine learning algorithm, to determine whether a further update to the updated user input option(s) is necessary based on changes to the user profile, as described herein.

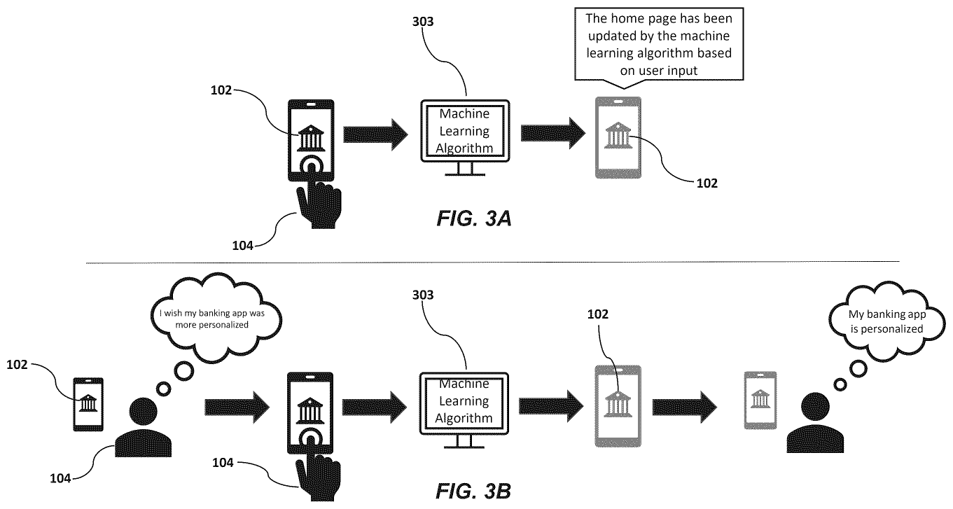

FIG. 3A is a schematic diagram illustrating a machine learning algorithm updating a digital application in accordance with some embodiments of the present disclosure. In some embodiments, the digital application is the banking application 102. In some embodiments, the user 104 interacts with the banking application 102 and the machine learning algorithm 303 uses data gathered from user interactions to personalize the banking application 102. The user 104 may interact with the banking application 102 by navigating the banking application 102 and using features of the banking application 102. For example, a user may frequently use a digital check deposit feature of the banking application 102 to deposit paychecks that the user receives every Friday. Data regarding the user's frequent use of the digital check deposit feature on Fridays may be provided to the machine learning algorithm 303 and the machine learning algorithm 303 may provide the user a shortcut to the digital check deposit feature on a home screen of the banking application 102 on Fridays.

FIG. 3B is a schematic diagram illustrating a machine learning algorithm 303 personalizing a digital application in accordance with some embodiments of the present disclosure. In some embodiments, the digital application is the banking application 102. In some embodiments, the user 104 may interact with the banking application 102. In some embodiments, the machine learning algorithm 303 uses data gathered from user 104 interactions to personalize the banking application 102, thus satisfying the preferences of user 104.

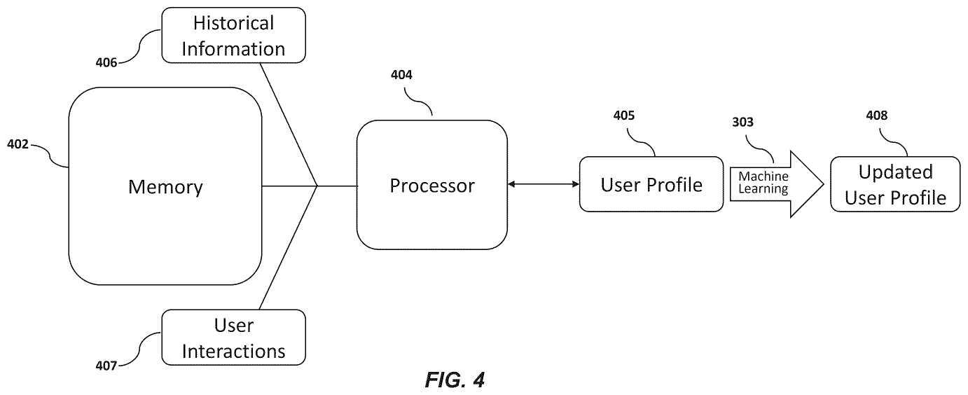

FIG. 4 is a schematic diagram illustrating data inputs used to update a user profile 405 using the machine learning algorithm 303 in accordance with some embodiments of the present disclosure. In some embodiments a processor 404, in communication with a memory 402, executes instructions stored on the memory 402 to create and update a user profile 405 of a digital application. In some embodiments, the processor uses historical information 406 and user interactions 407, stored on memory 402, to create the user profile 405. In some embodiments the processor executes instructions to utilize the machine learning algorithm 303 to update the user profile 405 based on the historical information 406 and user interactions 407, creating an updated user profile 408.

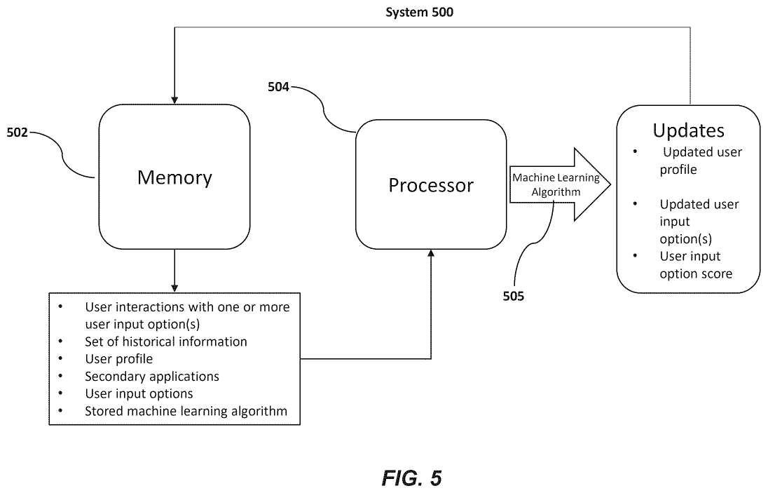

FIG. 5 is a schematic diagram illustrating a system 500 for updating a user profile in accordance with some embodiments of the present disclosure. In some embodiments, the system 500 includes a memory 502 that stores data in communication with a processor 504. In some embodiments, the data stored by memory 502 includes user interactions with one or more user input options, a set of historical information, a user profile, one or more secondary applications, user input options, and one or more machine learning algorithms. In some embodiments, the processor 504 uses the data stored on memory 502 to execute a machine learning algorithm 505. In some embodiments, the machine learning algorithm 505 is used to update a user profile, as described herein. In some embodiments, the machine learning algorithm is used to update user input options on a digital application, as described herein. In some embodiments, the machine learning algorithm is used to update a user input option score, as described herein.

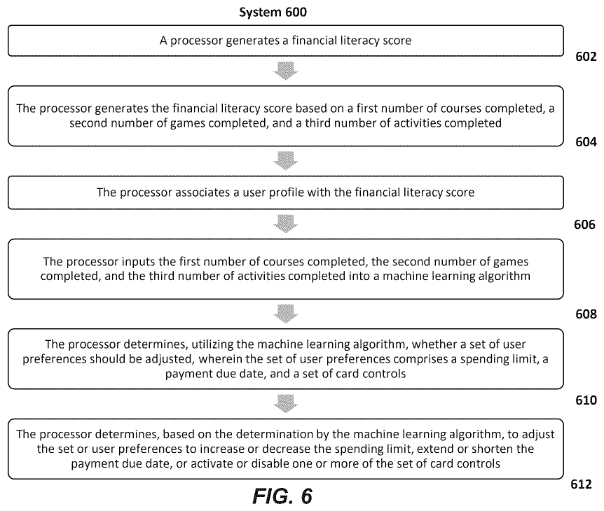

FIG. 6 is a flowchart illustrating a system 600 for updating account preferences of digital application in accordance with some embodiments of the present disclosure. In some embodiments, the system 600 includes a step 602 where a processor generates a financial literacy score. On some embodiments, the system 600 includes a step 604 where the processor generates the financial literacy score based on a first number of courses completed, a second number of games completed, and a third number of activities completed. In some embodiments, the system 600 includes a step 606 where the processor associates a user profile with the financial literacy score.

In some embodiments, the system 600 includes a step 608 where the processor inputs the first number of courses completed, the second number of games completed, and the third number of activities completed into a machine learning algorithm. In some embodiments, the system 600 includes a step 610 where the processor determines, utilizing the machine learning algorithm, whether a set of account preferences should be adjusted, wherein the set of account preferences comprises a spending limit, a payment due date, and a set of card controls. In some embodiments, the system 600 includes a step 612 where the processor determines, based on the determination by the machine learning algorithm, to adjust the set of account preferences to increase or decrease the spending limit, extend or shorten the payment due date, or activate or disable one or more of the set of card controls.

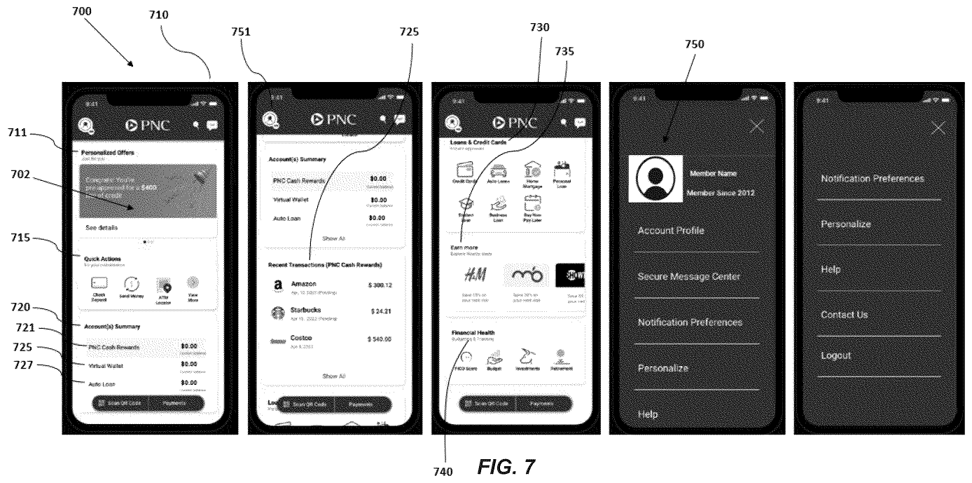

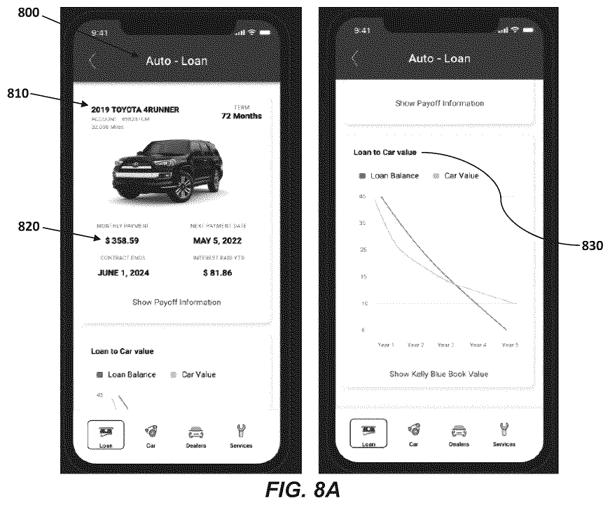

FIG. 7 illustrates an example of a home page 710 of a personalized banking application 700. The home page 710 is displayed on a graphical user interface 702 of a mobile device. In some embodiments the personalized banking application 700 includes a variety of secondary applications, some of which are displayed on the home page 710. In some embodiments the plurality of secondary applications may include a quick actions application 715, an account summary application 720, a recent transactions application 725, a loans and credit cards application 730, a shopping offers application 735, a personal offers application 711, a payments application, a family share application, and/or a financial health application. In some embodiments, the home page 710 contains a personalized account feature 750. In some embodiments, the user can access the personalized account feature 750 by selecting a personalized account feature icon 751 on the graphical user interface 702.

In some embodiments the quick actions application 715 may provide access to commonly used digital application functions including a check deposit action, a send money action, an ATM locator action, and/or a pay balance option.

In some embodiments, the account summary application 720 may provide the user with a summary of their account information including a current balance of cash rewards 721, a current balance of a virtual wallet 725, and/or a current balance of an auto loan 727.

In some embodiments the recent transactions application 725 may provide a summary of recent transactions made by the user including credit card transactions, recent cash rewards transactions, debit card transactions, digital transactions such as wire transfers, and other transactions linked to the personalized banking application 700.

In some embodiments the loans and credit cards application 730 may provide the user with credit and loan information and actions including an instant approval action for credit cards, for auto loans, for home mortgages, for personal loans, for student loans, for business loans, and/or for buy now pay later programs.

In some embodiments, the shopping offers application 735 may provide the user with one or more shopping offers including offers that may be used online or in-store. In some embodiments, the loans and credit cards application 730 includes a set of information related to a user vehicle.

In some embodiments the financial health application 740 may provide the user with financial health information including a FICO score tracking feature, a budget feature, an investment feature, and/or a retirement plan feature.

In some embodiments, the personalized account feature 750 may include a user's name, a user's email address, and a user's year of membership. In some embodiments, the personalized account feature 750 may include a portal to an account profile, a portal to a secure message center, a portal to a notification preferences feature, a portal to a personalization feature, a portal to a help feature, a portal to a contact the application manager and a portal to a logout feature.

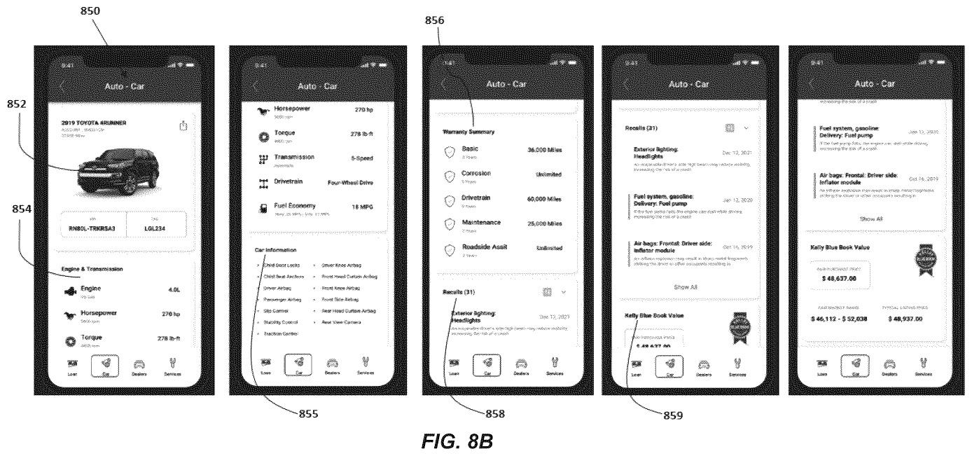

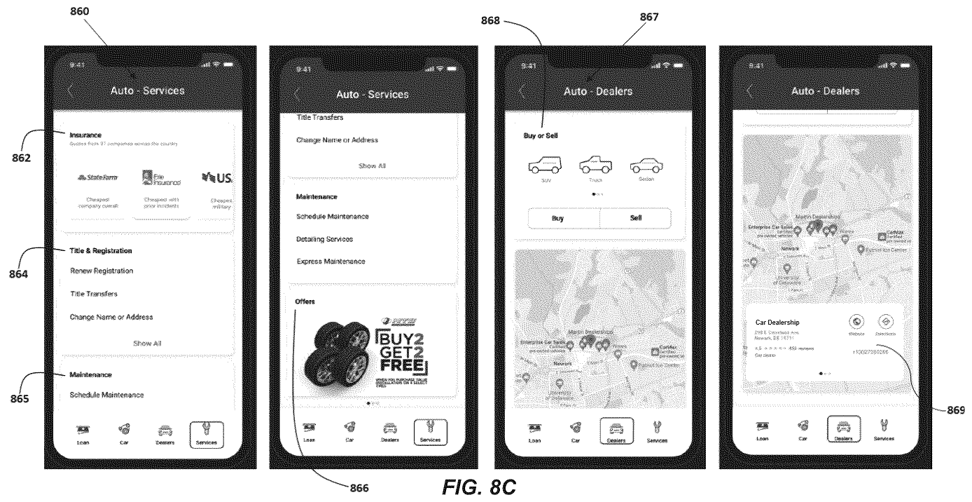

FIG. 8A illustrates an example of a vehicle loan feature 800 of the personalized banking application. In some embodiments, the vehicle loan feature 800 may include information about a vehicle loan displayed in a convenient way for the user. In some embodiments, the vehicle loan feature may include vehicle identifying information 810 such as a loan account number, a vehicle make, a vehicle model, a vehicle year, and a vehicle milage. In some embodiments the vehicle loan feature 800 may include loan information 820 such as a loan term, a monthly payment amount, a next payment date, a contract end date, and/or an interest paid year-to-date amount. In some embodiments, the vehicle loan feature 800 may include one or more charts 830 depicting vehicle loan balance over time and/or vehicle value over time. In some embodiments, the vehicle loan feature includes an option to provide a Kelly Blue Book Value or other vehicle value estimate of the user's vehicle.

FIG. 8B is an illustration of a vehicle summary feature 850 of the personalized banking application. In some embodiments the vehicle summary feature 850 may provide the user with one or more sub-features that provide vehicle-related information to the user. In some embodiments the vehicle summary sub-features may include a vehicle identity feature 852, an engine and transmission summary feature 854, a vehicle information feature 855, a vehicle warranty feature 856, a vehicle recall feature 858, and/or a vehicle value feature 859.

In some embodiments the vehicle identity feature 852 may provide the user with vehicle-identifying information including information such as VIN number, and/or license plate number.

In some embodiments the engine and transmission summary feature 854 may provide the user with information on the vehicle's engine and transmission including information such as engine type, engine horsepower, engine torque, drivetrain type, and/or vehicle fuel economy.

In some embodiments the vehicle information feature 855 may include information on whether certain vehicle features such as child door locks, child seat anchors, driver airbag, passenger airbag, slip control, stability control, traction control, driver knee airbag, front head curtain airbag, front knee airbag, front side airbag, rear head curtain airbag, and/or rear-view camera are engaged.

In some embodiments the vehicle warranty feature 856 may provide the user with vehicle warranty-related information including basic warranty information, corrosion warranty information, drivetrain warranty information, maintenance warranty information and/or roadside assistance warranty information.

In some embodiments the vehicle recall feature 858 may provide the user with a number of vehicle-related recalls. In some embodiments the vehicle recall feature 858 may include a description of a recall. In some embodiments, the vehicle value feature 859 may include a fair purchase price, a fair market range, and/or a typical listing price. In some embodiments the fair purchase price, the fair market range, and/or the typical listing price may be provided by a third-party source, such as Kelly Blue Book.

FIG. 8C is an illustration of a vehicle services feature 860 of the personalized banking application. In some embodiments, the vehicle services feature 860 may include a vehicle insurance feature 862, a vehicle title and registration feature 864, a vehicle maintenance feature 865, and/or a vehicle offers feature 866.

In some embodiments, the vehicle offers feature 866 may include a set of vehicle-related offers 864. In some embodiments, the set of vehicle-related offers 866 may include at least one of an insurance partner offer, a vehicle maintenance offer, a vehicle parts offer, and/or a vehicle loan refinancing offer. In some embodiments, the set of vehicle-related offers 866 may include a notification to renew a vehicle registration and a notification to service the vehicle.

In some embodiments the vehicle services feature 860 may include a vehicle dealers feature 867. In some embodiments, the vehicle dealers feature 867 may include a vehicle buy or sell feature 868, and/or a vehicle dealership locator feature 869. In some embodiments, the vehicle buy or sell feature 868 may include a buy/sell SUV feature, a buy/sell truck feature, a buy/sell sedan feature, and/or a buy/sell motorcycle feature. In some embodiments the vehicle dealership locator feature 869 may include a map giving the location of nearby vehicle dealers. In some embodiments the map giving the location of nearby vehicle dealers may be provided via a third-party application such as Google Maps.

In some embodiments, the vehicle insurance feature 862 may include one or more insurance quotes from different vehicle insurers. In some embodiments, the vehicle insurance feature 862 may provide personalized insights to the one or more insurance quotes. In some embodiments, the personalized insights may include insights into overall quote value, quote value if a driver has had prior incidents, and quote value for specific categories of individuals, including but not limited to military veterans, and/or teen drivers.

In some embodiments, the vehicle title and registration feature 864 may include a renew registration option, a title transfer option, and/or a change name or address option.

In some embodiments, the vehicle maintenance feature 865 may provide the user with vehicle maintenance options including a schedule maintenance feature, a detailing services feature, and an express maintenance feature.

In some embodiments the vehicle offers feature 866 may provide the user with one or more vehicle-related offers including discounts and/or promotions for vehicle related items such as tires.

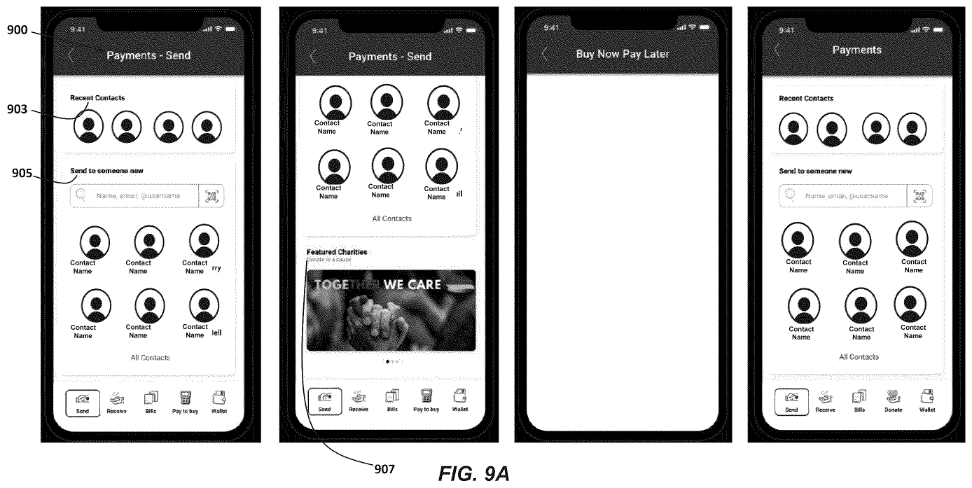

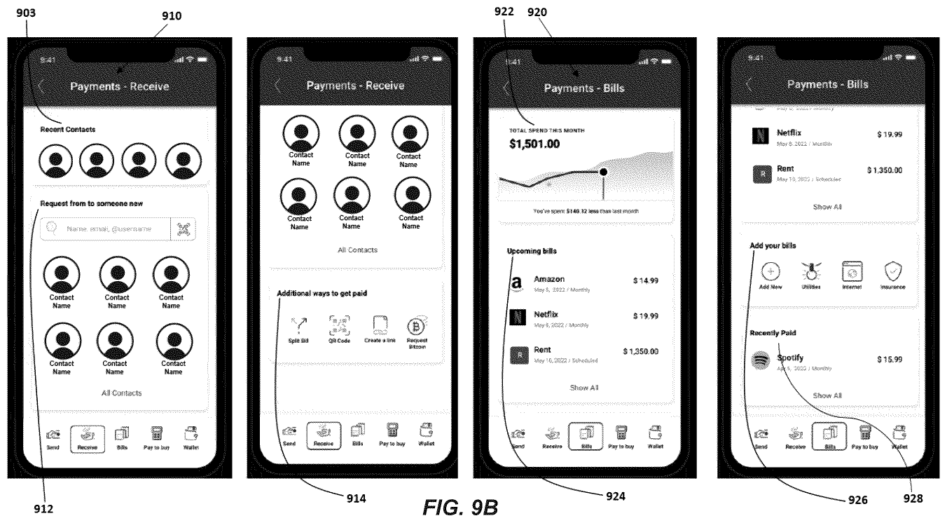

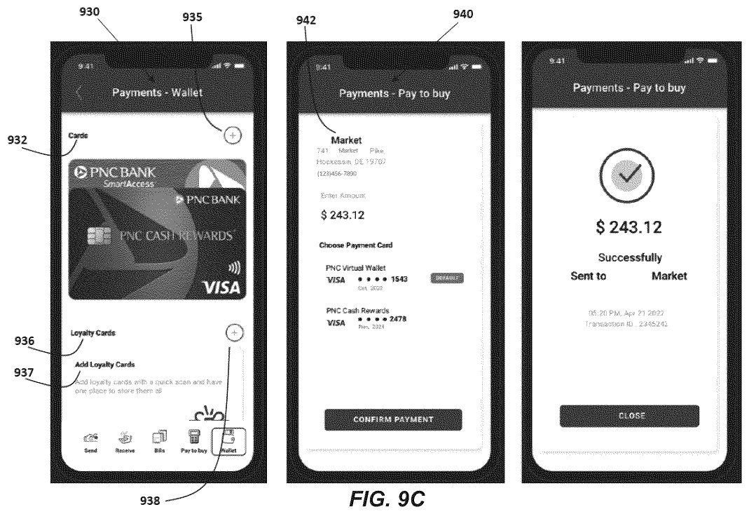

FIG. 9A is an illustration of the send payments feature 900 of the personalized banking application. In some embodiments the send payments feature 900 may include a recent contacts list 903 that displays the name, and/or image of one or more contacts with whom the user has recently interacted so that the user can conveniently select the contact and send a payment to the contact.

In some embodiments the send payments feature 900 may include a send to someone new feature 905. In some embodiments the send to someone new feature 905 may include a search bar where the user can search for a contact using the name, email, and/or username of the contact to send a payment to the contact. In some embodiments, the send to someone new feature 905 may display a contact list on the graphical user interface containing names and/or images of the user's contacts so that the user can select one or more contacts to send a payment.

In some embodiments, the send payments feature 900 may include a charities feature 907. In some embodiments, the charities feature 907 displays to the user options to donate to one or more charities on the graphical user interface allowing the user to send donations to the one or more charities.

FIG. 9B is an illustration of the receive payments feature 910 and a bill payment feature 920 of the personalized banking application. In some embodiments, the receive payments feature 910 may include the recent contacts list 903.

In some embodiments, the receive payments feature 910 may include a request from someone new feature 912. In some embodiments, the request from someone new feature 912 may include a search bar where the user can search for a contact using the name, email, and/or username of the contact to request a payment from the contact. In some embodiments, the request from someone new feature 912 may display a contact list on the graphical user interface containing names and/or images of the user's contacts so that the user can select one or more contacts to request a payment from the contact.

In some embodiments, the receive payments feature 910 may include an additional ways to get paid feature 914. In some embodiments, the additional ways to get paid feature 914 may include a bill splitting feature, a QR code scanning feature, a link creating feature and a Bitcoin request feature.

In some embodiments, the bill payment feature 920 may include a monthly spending total 922 that is displayed on the graphical user interface. In some embodiments, the bill payment feature 920 may track the user's past, current, and upcoming bills. In some embodiments, the monthly spending total 922 may be displayed graphically to the user. In some embodiments the current monthly spending total 922 may be compared to past monthly spending totals. In some embodiments, the bill payment feature 920 may include an upcoming bills feature 924. In some embodiments, the upcoming bills feature 924 may display, on the graphical user interface, one or more upcoming bills. In some embodiments, the upcoming bill feature 924 may display information on the one or more upcoming bills including an upcoming bill amount, an upcoming bill date, and an upcoming bill description. In some embodiments, of the upcoming bill feature, the upcoming bill description may include information on an upcoming bill destination and/or an upcoming bill purpose. In some embodiments, the upcoming bill destination may be a business name. In some embodiments, an upcoming bill purpose may be rent, or a car payment.

In some embodiments, the bill payment feature 920 may include an add your bills feature 926. In some embodiments, the add to your bills feature 926 may allow the user to add bills that were previously unrecorded in the digital application. In some embodiments, the add your bills feature 926 may include an add new feature that allows the user to add one or more new bills to the bill payment feature 920. In some embodiments, the add your bills feature 926 may include a utility bill feature, an internet bill feature, and/or an insurance bill feature that may allow the user to add new utility, internet, and insurance bills to the bill payment feature 920.

In some embodiments, the bill payment feature 920 may include a recently paid bill feature 928. In some embodiments, the recently paid bill feature 928 may display, on the graphical user interface, one or more recently paid bills. In some embodiments, the recently paid bill feature 928 may display information on the one or more recently paid bills including a recently paid bill amount, a recent bill payment date, and a recently paid bill description. In some embodiments, the recently paid bill description may include information on a recently paid bill destination and/or a recently paid bill purpose. In some embodiments the recently paid bill destination may be a business name. In some embodiments the recently paid bill purpose may be a rent or car payment.

FIG. 9C is an illustration of a wallet feature 930 and a pay to buy feature 940 of a personalized banking application. In some embodiments, the wallet feature 930 may include a cards feature 932.

In some embodiments, the cards feature 932 may include one or more digital credit and/or debit cards. In some embodiments, the wallet feature 930 may include an add a new card feature 934. In some embodiments, the add a new card feature 934 may be displayed as an add new card icon 935 on the graphical user interface that may allow the user to add a new card to the wallet feature 930. In some embodiments, the cards feature 932 may allow the user to pay using a credit or debit card that has been uploaded to the cards feature 932. In some embodiments, the wallet feature 930 may include a loyalty card feature 936. In some embodiments, the loyalty cards feature 936 may include an add a new loyalty card feature 937. In some embodiments, the add new loyalty card feature 937 may be displayed as an add new loyalty card icon 938 on the graphical user interface that, when selected, allows the user to add a new loyalty card, such as a restaurant loyalty card or a grocery store loyalty card, to the loyalty cards feature 936.

In some embodiments, the pay to buy feature 940 may include a proposed transaction 942. In some embodiments, the proposed transaction 942 includes proposed transaction information that may include a name of a transacting party, a transacting party's address, a transacting party's phone number, a transacting party's email and a transacting party's other contact information. In some embodiments, the proposed transaction information may include a proposed transaction amount.

In some embodiments, the pay to buy feature 940 may include a choose payment option feature. In some embodiments, the choose payment option feature may include one or more credit cards, debit cards, virtual wallets, and/or online banking accounts. In some embodiments, the pay to buy feature 940 may include a confirm payment option, displayed on the graphical user interface, that can be selected by the user to complete the proposed transaction. In some embodiments, after the user selects the confirm payment option, a banner conforming payment may be displayed on the graphical user interface.

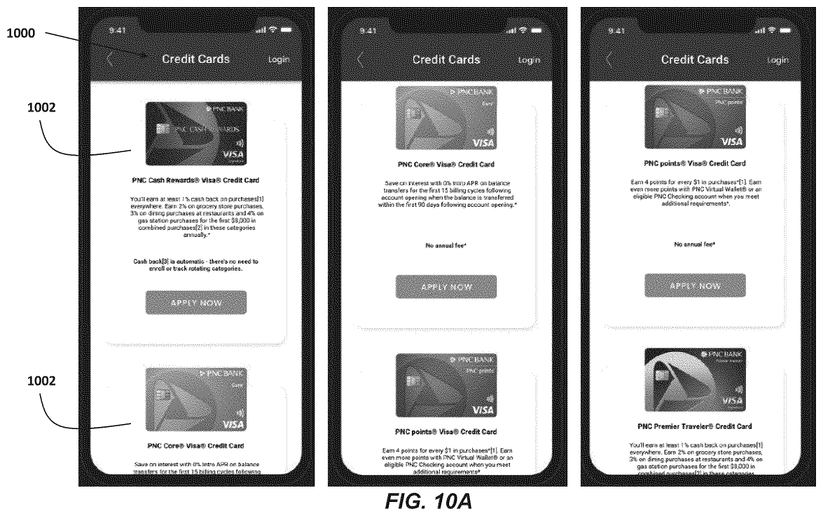

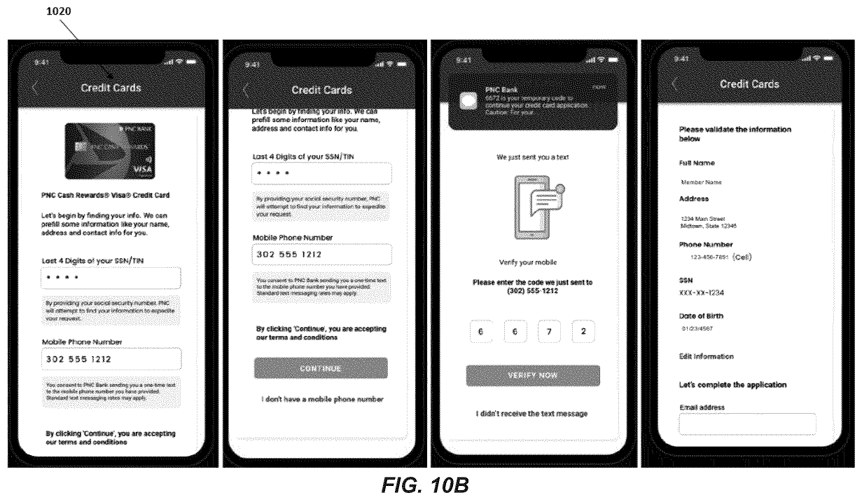

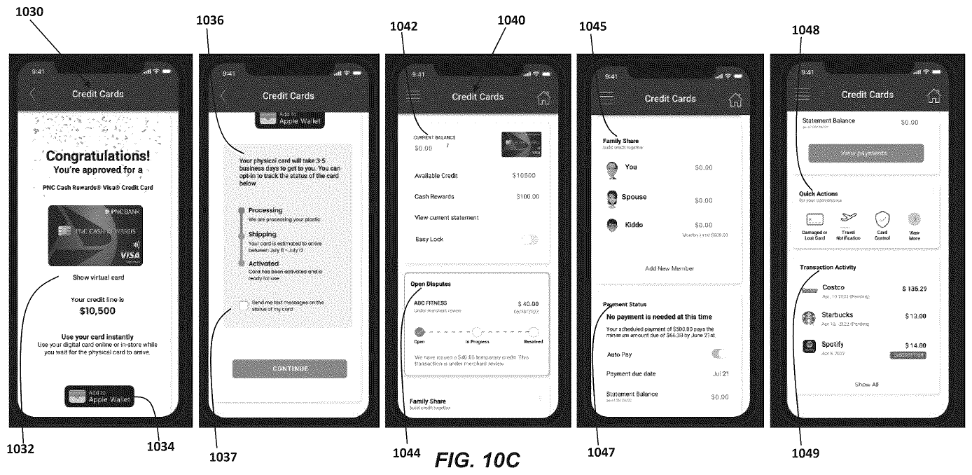

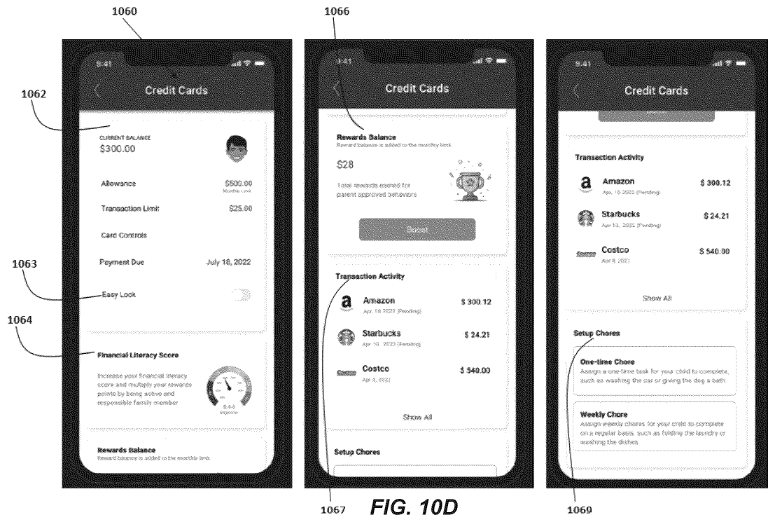

FIG. 10A is an illustration of a credit cards shop 1000 of a personalized banking application. In some embodiments, the credit cards shop 1000 may include one or more credit card application options 1002 that allow the user to apply for a credit card via the personalized banking application. In some embodiments, the credit cards shop may include a credit card name, a credit card description, and an apply now feature. In some embodiments, the credit card description may include rewards information, interest payment information, and/or additional requirements. In some embodiments, the apply now feature is displayed on the graphical user interface and links the user to a digital credit card application 1020, depicted in FIG. 10B.

FIG. 10B is an illustration of the digital credit card application 1020. In some embodiments, the digital credit card application 1020 may require the user to input user information to apply for the credit card via the personalized banking application. In some embodiments, the user information may include the last four digits of the user's social security number and/or the user's mobile phone number. In some embodiments, the personalized banking application may display, on the graphical user interface, an explanation for why the requested user information is needed. In some embodiments, the personalized banking application may prefill the requested user information if the user has previously provided the same information in other contexts. In some embodiments, the credit card application 1020 may require a two-step verification. In some embodiments, step one of the two-step verification may include providing required user information. In some embodiments, step two of the two-step verification may include providing a temporary verification code that is sent to the user via text after the user completes step one of the two-step verification. In some embodiments, the user may not be able to continue the credit card application until the user has provided the temporary verification code. In some embodiments, the digital credit card application 1020 may request that the user verify personal information including the user's full name, address, phone number, social security number, and date of birth. In some embodiments, the credit card application 1020 may request that the user provide an email address. In some embodiments, after the user provides the email address, the credit card application 1020 may be complete.

FIG. 10C is an illustration of a credit card approval page 1030 and a credit card summary page 1040 of a personalized banking application. In some embodiments, after the credit card application 1020 is complete, the personalized banking application may display the credit card approval page 1030, if the credit card application is approved, on the graphical user interface to inform the user if the credit card application 1020 has been approved or denied. In some embodiments, the credit card approval page 1030 may alert the user as to the amount of credit extended to the user. In some embodiments, the credit card approval page 1030 may include an option to access a virtual embodiment of the credit card 1032. In some embodiments, the credit card approval page 1030 may include an option to add the credit card to a separate virtual wallet 1034. In some embodiments, the credit card approval page 1030 may include a physical credit card status timeline 1036. In some embodiments, the status timeline 1036 may display the status of a physical card. In some embodiments, the status of the physical card may be processing, shipping, activated, or deactivated. In some embodiments, a shipping status may include an estimated delivery date. In some embodiments an activated status may include information on whether the card has been activated and is ready for use. In some embodiments, a deactivated status may indicate that the card was previously active but is currently deactivated. In some embodiments, the credit card approval page 1030 may give the user an option to receive text message update 1037 on the status of the physical card.

In some embodiments, the credit card summary page 1040 may include a credit card identifier. In some embodiments, the credit card identifier may be a graphical depiction of the card and/or a name of the card. In some embodiments the credit card summary page 1040 may include a credit card summary 1042. In some embodiments, the credit card summary 1042 may display a current credit balance, an available credit amount, a cash rewards amount, a view current statement option, and/or an easy lock option. In some embodiments, the easy lock option may allow the user to lock the credit card so that it cannot be used via a single user input. In some embodiments, the single user input may be a digital lock button displayed on the graphical user interface. In some embodiments, the credit card summary page 1040 may include an open disputes feature 1044. In some embodiments, the open disputes feature 1044 may include a list of one or more open disputes as well as open dispute information. In some embodiments, the open dispute information may include a disputed transaction name, a disputed transaction status, a disputed transaction amount, a disputed transaction date, a disputed transaction graphic, and/or a temporary credit announcement. In some embodiments, the disputed transaction name may be the name of the business or party who received payment in the disputed transaction. In some embodiments, the disputed transaction status may give the user information on such as, submitted, under merchant review, or complete. In some embodiments, the disputed transaction graphic may graphically display information on whether a dispute is open, in progress, or resolved. In some embodiments, the temporary credit announcement may inform the user that a creditor has issued a temporary credit to the user while the disputed transaction is being reviewed. In some embodiments, the temporary credit is equal to the disputed transaction amount.

In some embodiments, the credit cards summary page 1040 may include a family share application 1045. In some embodiments the family share application 1045 may allow a user to control monthly allowances of a family share member. In some embodiments, family share members may include children, siblings, and/or other family members. In some embodiments, the family share application 1045 may display a current account balance for each family member. In some embodiments, the family share application 1045 may include an option to set transaction limits for the family share member. In some embodiments, the family share application 1045 may include an option to set card controls for the family share member. In some embodiments, the family share application 1045 may include an option to set payment due dates for the family share member. In some embodiments, the family share application 1045 may include a monthly spending limit to be imposed on one or more family members. In some embodiments, the family share application 1045 may allow the user to add new members.

In some embodiments, the credit cards summary page 1040 may include a payment status feature 1047. In some embodiments, the payment status feature 1047 may display a payment headline that indicates to the user if a payment is currently needed. In some embodiments, the payment status feature 1047 may include future payment information. In some embodiments, the future payment information may include the future payment date, the minimum future payment amount, and/or the scheduled future payment amount. In some embodiments, the payment status feature 1047 may include an autopay feature that allows the user to automate credit card payments. In some embodiments, the user may direct the autopay feature to pay a certain amount of money, including the current statement balance, on a scheduled payment due date. In one embodiment, the user may direct the autopay feature to pay the entire statement balance on the payment due date. In one embodiment, the payment status feature 1047 may allow the user to view one or more payments. In some embodiments, the one or more payments may be past or future payments.

In some embodiments, the credit cards summary page 1040 may include a quick actions feature 1048. In some embodiments, the quick actions feature 1048 may include a damaged or lost card feature, a travel notification feature, and/or a card control feature. In some embodiments, the damaged or lost card feature may allow the user to report a damaged or lost card. In some embodiments, the damaged or lost card feature may allow the user to report incident information about the event that led to the damage to the card or the loss of the card. In some embodiments, the incident information may include a card name, a type of damage to the card, and/or a geographical location of the incident that led to the loss or damage of the card. In some embodiments, the quick actions feature 1048 may include a travel notification feature. In some embodiments, the travel notification feature may allow the user to notify a credit card company that the user is planning on traveling. In some embodiments, the travel notification feature may allow the user to notify the credit card company of the country, state, and/or region where the user plans to travel. In some embodiments, the travel notification feature may allow the user to enable the personalized banking application to track the user's location via the user's electronic device, such that when a credit card transaction occurs, the location of the transaction and the user's location can be matched. A matching user location and transaction location would indicate a higher likelihood that any given transaction is trustworthy and was made by the user. In some embodiments, the quick actions feature 1048 may include a card control feature. In some embodiments, the card control feature may allow the user to temporarily disable one or more cards.

In some embodiments, the credit cards summary page 1040 may include a transaction activity feature 1049. In some embodiments, the transaction activity feature 1049 may track transaction activity and transaction information on one or more credit cards. In some embodiments, the transaction information may include transacting party, transaction date, transaction amount, whether the transaction is pending, and/or whether the transaction was a subscription transaction.

FIG. 10D is an illustration of a child user feature 1060 of the personalized banking application. In some embodiments, the child user feature 1060 may include a child control center 1062 that a parent or guardian can use to set an allowance, a transaction amount limit, and/or card controls. In some embodiments, the child control center 1062 may also include an easy lock feature 1063 that can be used to lock the child's use of one or more credit cards. In some embodiments, the child user feature 1062 may include a child financial literacy feature 1064. In some embodiments, the child financial literacy feature 1060 may include a child financial literacy score. In some embodiments, the child user feature 1060 may include a child rewards balance 1066 that is added at the parent or guardian's discretion. In some embodiments, the parent or guardian may set up a child rewards program that adds a predetermined amount of money whenever the child completes a parent approved task or behavior.

In some embodiments, the child user feature 1060 may include a child transaction activity feature 1067. In some embodiments, the child transaction activity feature 1067 may include child transaction information such as transacting party, transaction date, transaction amount, whether the transaction is pending, and/or whether the transaction was a subscription transaction.

In some embodiments, the child user feature 1060 may include a setup chores feature 1069. In some embodiments, the setup chores feature 1069 may include a one-time chore option and/or a weekly chore option. In some embodiments, the one-time chore option may allow a parent or guardian to assign a one-time task to the child to complete such as washing the car or giving the dog a bath. In some embodiments, the weekly chore option may allow the parent or guardian to assign weekly chores to a child to complete on a regular basis, such as folding the laundry or washing the dishes. In some embodiments, the parent or guardian may link the setup chores feature 1069 and the rewards program so that rewards are given when the child completes one or more one-time and/or weekly chores.

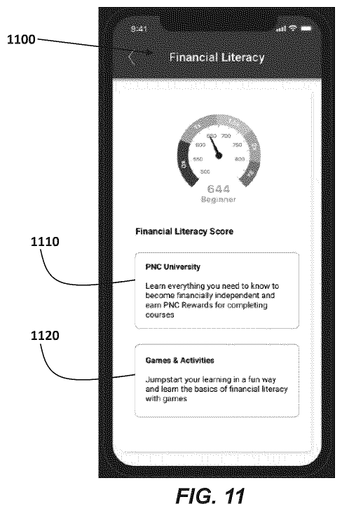

FIG. 11 is an illustration of a financial literacy feature 1100 of the personalized banking application. In some embodiments, the financial literacy feature 1100 may include a financial course feature 1110 that allows a user to complete courses that teach the user financial independence. In some embodiments, the financial literacy feature 1100 may allow the user to earn rewards for completing parts of the financial course feature 1110. In some embodiments, the financial literacy feature 1100 may include a games and activities feature 1120 that teaches basic financial literacy through courses, games, and activities. In some embodiments, the games and activities feature 1120 may allow the user to earn rewards for completing games and activities.

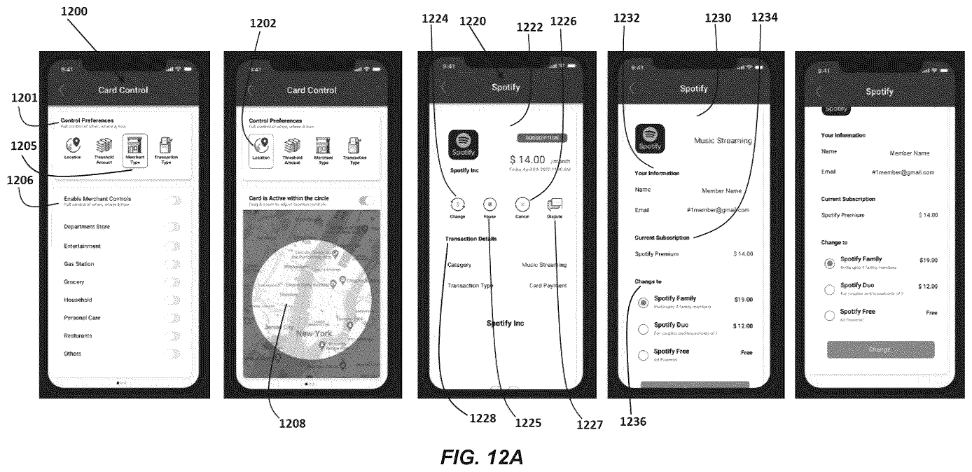

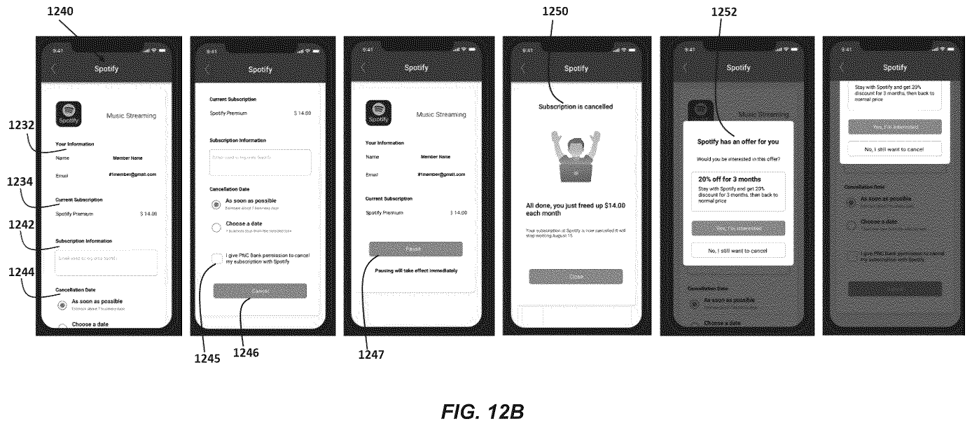

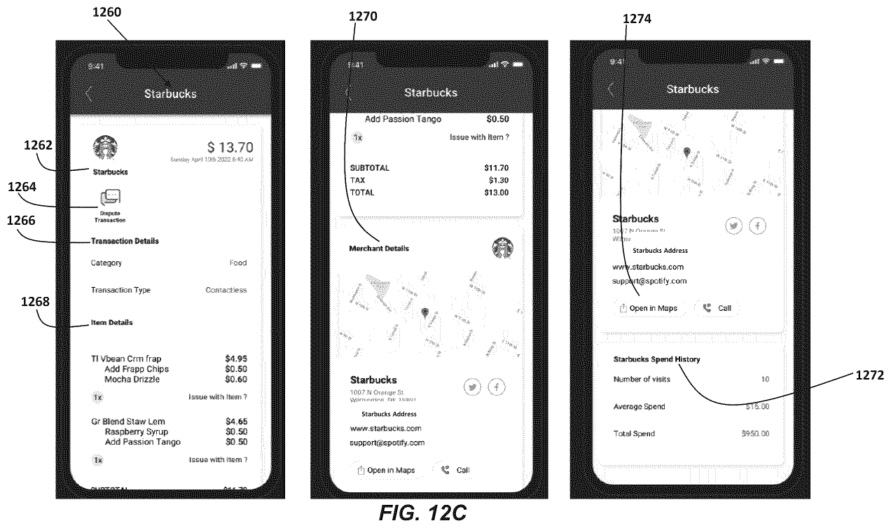

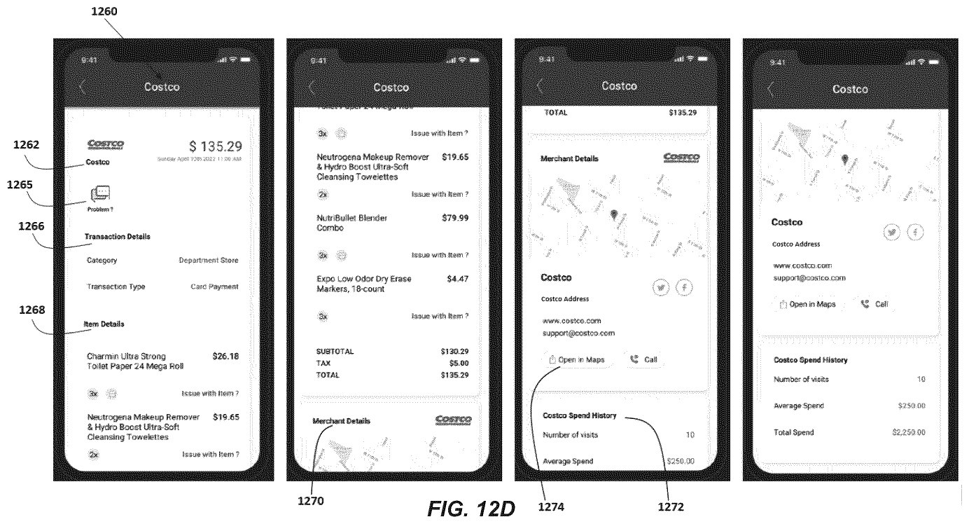

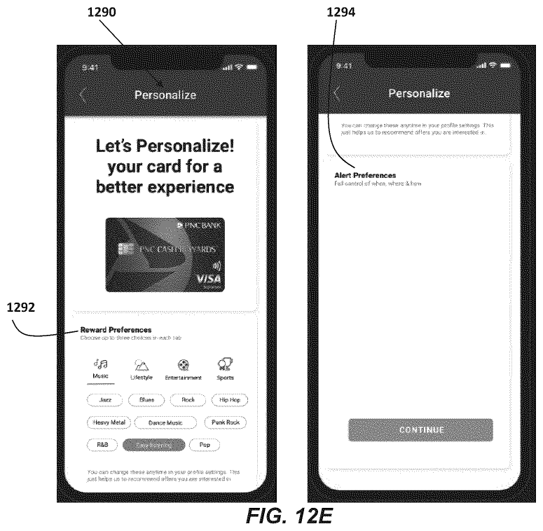

FIG. 12A is an illustration of a card control feature 1200 and a third-party subscription management feature 1220 of the personalized banking application. In some embodiments, the card control feature 1200 may allow the user to disable one or more cards. In some embodiments, the card control feature 1200 may include one or more control preferences 1201. In some embodiments, the one or more control preferences 1201 may include a location preference 1202, an amount threshold preference, a merchant type preference 1205, and/or a transaction type preference. In some embodiments, the merchant type preference 1205 may include an enable merchant controls option 1206. In some embodiments, the enable merchant controls option 1206 includes a user input option to enable or disable merchant controls. In some embodiments, merchant controls option 1206 may include one or more user input options to enable or disable merchant controls in one or more merchant categories. In some embodiments, one or more user input options may allow the user to enable or disable transactions between the card and the one or more merchant categories. In some embodiments, the one or more merchant categories may include department stores, entertainment, gas stations, grocery stores, household, personal care, restaurants, and/or others. For example, the user may enable merchant controls and only allow card purchases to be made at gas stations and grocery stores. In another example, the user may disable all merchant controls and allow unrestricted purchasing with the card.

In some embodiments, the location preference 1202 may allow a user to limit the geographical location where a card can be used. In some embodiments, the location preference allows the user to interact with a map 1208, displayed on the graphical user interface, to select an area where the card is active. In some embodiments, the location preference 1202 may be enabled or disabled by user interaction with the graphical user interface. The location preference 1202 may include an exception for online transactions or may include an override for online transactions. The location preference may include an override option for transactions on an individual basis.

In some embodiments, the third-party subscription management feature 1220 may allow a user to manage a third-party subscription via the personalized banking application. In some embodiments, the third-party subscription management feature 1220 may include a third-party subscription overview page 1222. In some embodiments, the third-party subscription overview page 1222 may include a change option 1224, a pause option 1225, a cancel option 1226 and a dispute option 1227. In some embodiments, the third-party subscription modification feature 1220 may include a subscription transaction details feature 1228. In some embodiments, the subscription transaction details feature 1228 may provide information on a subscription category, such as music streaming or internet service, and subscription transaction type, such as card payment or direct withdrawal. In some embodiments, the change option 1224 may allow the user to change subscription type to a higher or lower tier third party subscription. In some embodiments, the pause option may allow a user to temporarily pause a third-party subscription. In some embodiments, when the user pauses a subscription, the pause may take effect immediately. In some embodiments, the cancel option 1226 may allow a user to cancel a third-party subscription. In some embodiments, the user may be required to select an option that gives the personalized banking application permission to cancel the user's third-party subscription prior to cancelation.

In some embodiments, if the user selects the change option 1224, the user may be directed to a change subscription page 1230. In some embodiments, the change subscription page 1230 may include subscribing user information 1232, a current subscription 1234, and/or a change to feature 1236. In some embodiments, the subscribing user information 1232 includes the user's name, email address and other user identification information. In some embodiments, the current subscription 1234 may display information regarding the user's current subscription plan such as plan name and plan price. In some embodiments, the change to feature may display information on other subscription plan options such as other subscription plan names, other subscription plan prices, and other subscription plan details.

FIG. 12B is an illustration of a cancel subscription page 1240. In some embodiments, if the user selects the cancel option 1226, the user may be directed to the cancel subscription page 1240. In some embodiments, the cancel subscription page 1240 may include the subscribing user information 1232, the current subscription 1234, a subscription information input option 1242, and/or a subscription cancellation date option 1244. In some embodiments, the subscription information input option 1242 may prompt the user to input the user email address that is used to log onto the third-party subscription.

In some embodiments, the cancelation date option 1244 may allow the user to select a cancel as soon as possible option, or a choose a date option. In some embodiments, the cancel as soon as possible option may display an estimated cancelation date. In some embodiments, the choose a date option may allow the user to select a date on which the subscription will be canceled. In some embodiments, after the user has selected to cancel the subscription, the graphical user interface may display a permission request 1245 that if selected, indicates that the user gives the digital application permission to cancel the subscription. In some embodiments, the cancel subscription page 1240 may display, on the graphical user interface, a cancel button 1246 that if selected will cancel the subscription. In some embodiments the cancel subscription page 1240, may display a pause button 1247, prior to cancelation, giving the user a chance to pause rather than cancel the subscription. In some embodiments, once the subscription has been canceled, the personalized banking application may display a subscription is cancelled notification 1250. In some embodiments, the subscription is canceled notification 1250 may indicate how much money the user has freed up per month as well as a date when the user will no longer be able to use the subscription. In some embodiments, after the subscription has been canceled, the personalized banking application may display a notification on graphical user interface extending to the user one or more offers from the third-party subscription 1252. In some embodiments, the one or more offers may be discounts applied if the user declines to cancel the third-party subscription. In some embodiments, after the one or more offers from the third-party subscription 1252 are presented to the user, the user may accept one or more of the offers from the third-party subscription 1252 and continue the subscription, or the user can decline the one or more offers from the third-part subscription and cancel the third-party subscription.

FIG. 12C is an illustration of a transaction overview feature 1260. In some embodiments, the transaction overview feature 1260 may display the merchant name 1262, a transaction dispute option 1264, transaction details 1266, item details 1268, merchant details 1270, and/or merchant spending history 1272 on the graphical user interface.

In some embodiments, the transaction details 1266 include the transaction category and the transaction type. In some embodiments the item details 1268 include the name of the one or more goods or services transacted for, the quantity of each good or service transacted for, the subtotal charged for the transaction, the tax charged for the transaction, and/or the total charged for the transaction. In some embodiments, the transaction details 1266 may include an issue with item option that allows the user to notify the merchant of any issues with the one or more goods or services that were transacted for.

In some embodiments, the merchant details 1270 may include the merchant name, the merchant address, the merchant web address, the merchant email, a call merchant feature, and/or one or more merchant social media links. In some embodiments, the merchant social media link may be a link to a merchant's social media page. In some embodiments, the one or more merchant social media links may be displayed as a social media company's logo. In some embodiments, the call merchant feature may be displayed as a button on the graphical user interface that when selected, directs the mobile device to call the merchant's phone number.

In some embodiments, the merchant details 1270 may include a map, displayed on the graphical user interface, that includes an icon indicating the merchant's geographical location on the map. In some embodiments, the merchant details 1270 may include a maps link 1274. In some embodiments, the maps link 1274 may allow the user to select the link that may take the user to a third-party maps application that may allow the user to view, or navigate to, the merchant's geographical location.

In some embodiments, the transaction overview feature 1260 may contain a merchant spending history 1272. In some embodiments, the merchant spending history 1272 may display, on the graphical user interface, a number of visits to the merchant, an average spend at the merchant, and a total spend at the merchant.

FIG. 12D is a further illustration of an embodiment of the transaction overview feature 1260. In some embodiments, the transaction overview feature 1260 may include a report problem feature 1265.

FIG. 12E is an illustration of a credit card personalization feature 1290. In some embodiments, the credit card personalization feature 1290 may include a rewards preferences feature 1292 and/or an alert preferences feature 1294. In some embodiments, the rewards preferences feature 1292 may allow the user to choose one or more preferred rewards categories. In some embodiments, the rewards categories may include a music rewards category, a lifestyle rewards category, an entertainment rewards category, and/or a sports rewards category. In some embodiments, the rewards preferences feature 1292 may allow the user to select up to three rewards choices from each of the preferred rewards categories. In some embodiments, the user's rewards choices may be changed at any time in a user profile settings feature. In some embodiments, the user's rewards choices may be inputted into a machine learning algorithm to generate personalized rewards options for the user.

In some embodiments, the alert preferences feature 1294 may allow the user to control when, where, and how the user receives alerts from the personal banking application.

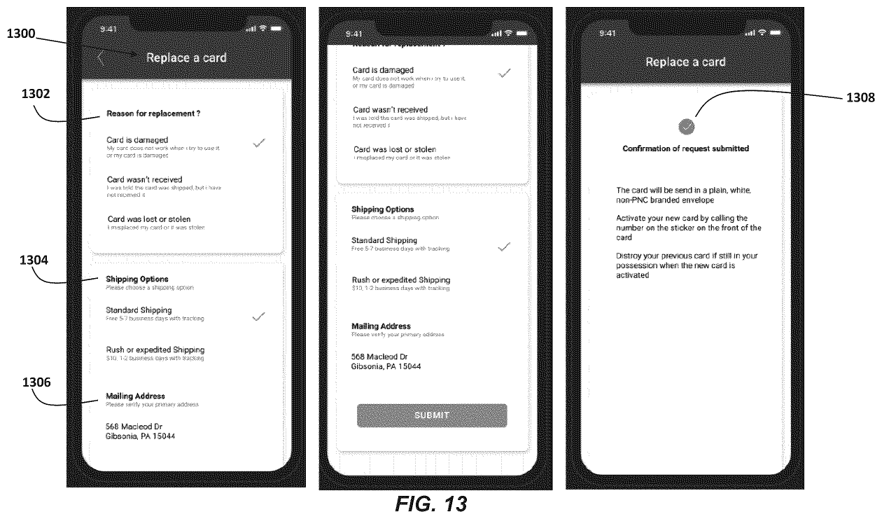

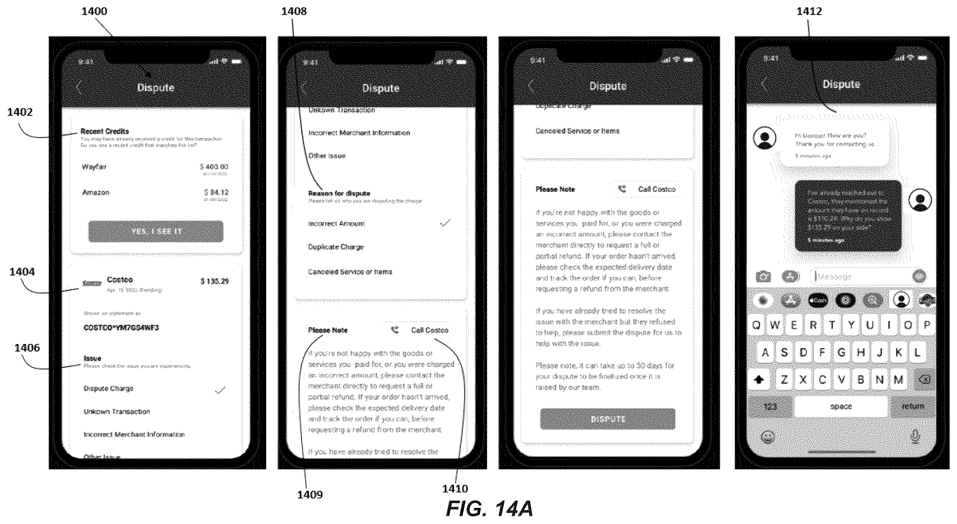

FIG. 13 is an illustration of a replace a card feature 1300 of a personalized banking application. In some embodiments, the replace a card feature 1300 may include a series of information requests that must be completed for the user to submit a request for a replacement card. The series of information requests may include a reason for replacement 1302, one or more shipping options 1304, and/or a mailing address 1306. In some embodiments, the reason for replacement 1302 may include one or more reasons that can be selected by the user to help describe why a replacement card is needed. In some embodiments, the one or more reasons may include the card is damaged, the card was not received and/or the card was lost or stolen. In some embodiments, the reason for replacement 1302 may include a more detailed description of the one or more reasons why the replacement card is needed. In some embodiments, the one or more shipping options 1304 may allow the user to select a standard shipping option or an expedited shipping option for the shipment of a new card. In some embodiments, the shipping options 1304 may include a description and a price of each shipping option. In some embodiments, the mailing address 1306 may prompt the user to input the user's primary address for shipping purposes. In some embodiments, the replace a card feature 1300 may include a submit button that is displayed on the graphical user interface. If the submit button is selected after the user has completed the series of information requests, the request for a replacement card may be submitted. In some embodiments, after the request for a replacement card is submitted, the replace a card feature 1300 may display a confirmation of request banner 1308 on the graphical user interface. In some embodiments the confirmation of request banner 1308 will give the user helpful information such as a mail identification instruction, new card activation instructions, and previous card destruction instructions.

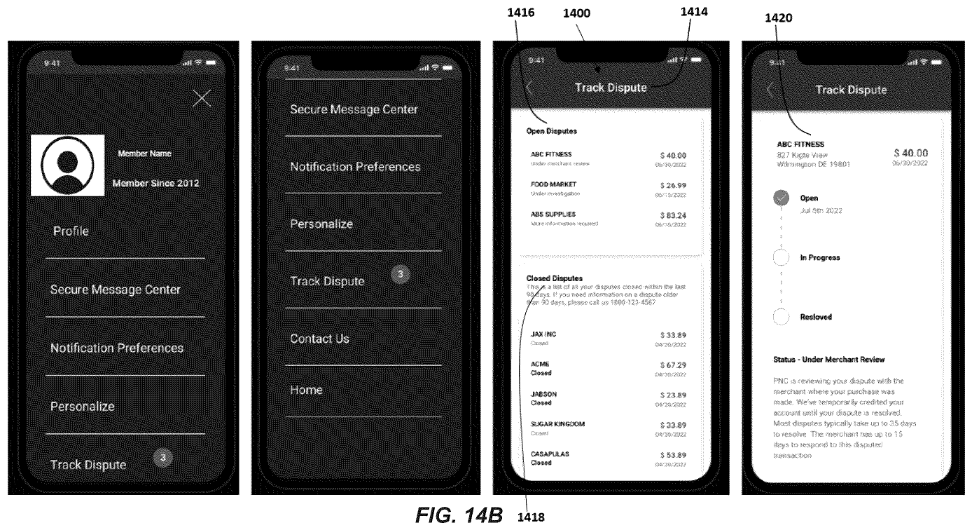

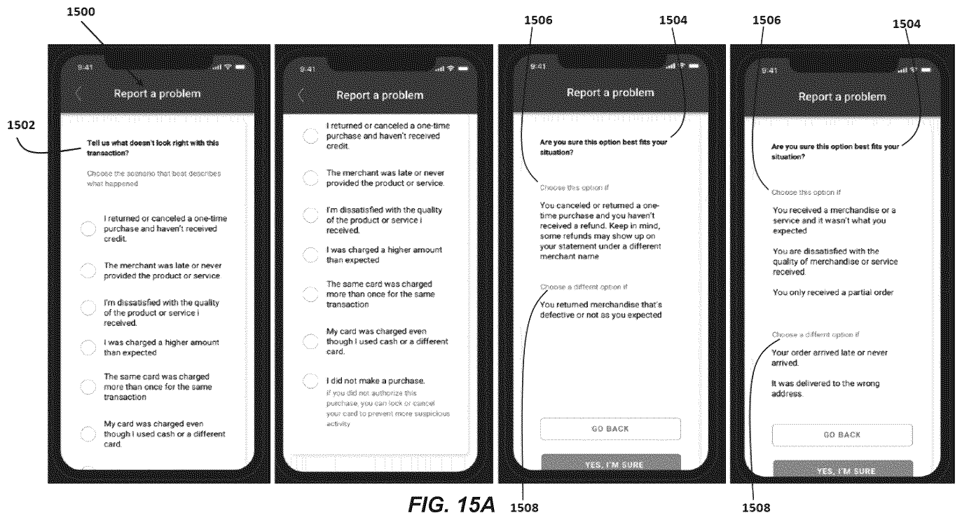

FIG. 14A is an illustration of a dispute a transaction feature 1400. In some embodiments, the dispute a transaction feature 1400 may include a recent credits feature 1402. In some embodiments, the recent credits feature 1402 may include a list of recent credits to the user's account. In some embodiments, the list of recent credits may include transaction information such as the merchant name, the amount credited to the user's account, and the date of the transaction. In some embodiments, the recent credits feature 1402 may include a prompt for the user to examine the recent credits on the list of recent credits and ensure that the user has not already received a credit for the transaction that the user seeks to dispute. If the user identifies that they have already received a credit for the transaction they wished to dispute, then the user may so indicate by selecting a yes I see it button on the graphical user interface.

In some embodiments, the dispute a transaction feature 1400 may include a transaction overview feature 1404. In some embodiments, the transaction overview feature 1404 may include the merchant name, the transaction amount, the transaction date, and a statement code. In some embodiments, the statement code may be a code shown on the credit card statement that corresponds to a given transaction. In some embodiments, the dispute a transaction feature 1400 may include an issue identification request 1406. In some embodiments, the issue identification request 1406 may include a list of potential transaction issues that the user can select to describe their issue with the transaction. In some embodiments, the list of potential transaction issues may include dispute a charge, unknown transaction, incorrect merchant information, and/or other issue. In some embodiments, the dispute a transaction feature 1400 may include a reason for dispute option 1408. In some embodiments, the reason for dispute option 1408 may allow the user to select one or more reasons to explain why they are disputing the charge. In some embodiments, the one or more reasons may include an incorrect amount, a duplicate charge, and/or canceled service or items. In some embodiments, the dispute a transaction feature 1400 may include a dispute explanation feature 1409. In some embodiments, the dispute explanation feature 1409 may include a written message to the user explaining that prior to disputing a transaction, the user should first attempt to contact the merchant directly and request a full or partial refund. In some embodiments, the dispute a transaction feature 1400 may include a call merchant button 1410 that when selected will call the merchant. In some embodiments, the written message to the user may explain that the user should submit a dispute if the merchant has refused to help. In some embodiments, the dispute a transaction feature 1400 may include a dispute submission button, displayed on the graphical user interface, that should be selected after the user has completed the disputed transaction information request, to submit the dispute.

In some embodiments, the dispute a transaction feature 1400 may include a chat feature 1412. In some embodiments, the chat feature 1412 may allow the user to chat via instant messaging with a personalized banking application representative. In some embodiments, the chat feature 1412 can be used to help the user dispute a transaction.

FIG. 14B is an illustration of one embodiment of the dispute a transaction feature 1400 and another embodiment of the personalized account feature of the personalized banking application. In some embodiments, the dispute a transaction feature 1400 may include a track dispute feature 1414. In some embodiments, the track dispute feature 1414 may include a list of open disputes 1416 and a list of closed disputes 1418. In some embodiments, the list of open disputes 1416 may contain the merchant name, the disputed transaction date, the disputed transaction amount, and a dispute status. In some embodiments, the dispute status may include information such as whether the dispute is under merchant review, under investigation, or if more information is required. In some embodiments, the list of closed disputes 1418 may include the merchant name, the disputed transaction date, the disputed transaction amount, and the dispute status. In some embodiments, the list of closed disputes 1418 may only include disputes closed within the last 90 days. In some embodiments, the list of closed disputes 1418 may include a phone number that the user can call if the user wants information about past disputes that are no longer included on the list because they occurred more than 90 days ago. In some embodiments, the user may, through interaction with the graphical user interface, select a dispute to open a dispute details feature 1420 regarding the selected dispute.

In some embodiments, the dispute details feature 1420 may include a dispute status graphic that is displayed on the graphical user interface. In some embodiments, the dispute status graphic may display the phases of a dispute and indicates which phases have been completed. In some embodiments, the phases of a dispute may include open, in progress, and resolved. In some embodiments, a green check or other icon indicating completion may be displayed, on the graphical user interface, beside a completed dispute phase. For example, in some embodiments, a check mark icon may be displayed beside the open phase, but no check mark icon is displayed beside the in progress or resolved phase indicating that only the open phase is complete. In some embodiments, the dispute details feature 1420 may include a detailed status description. In some embodiments, the detailed status description may give the user information such as whether the user's account has been temporarily credited until the dispute is resolved, an average dispute time, and information about the merchant's response period.

In some embodiments, the personalized account feature of the personalized banking application may include a link to the track dispute feature 1414.

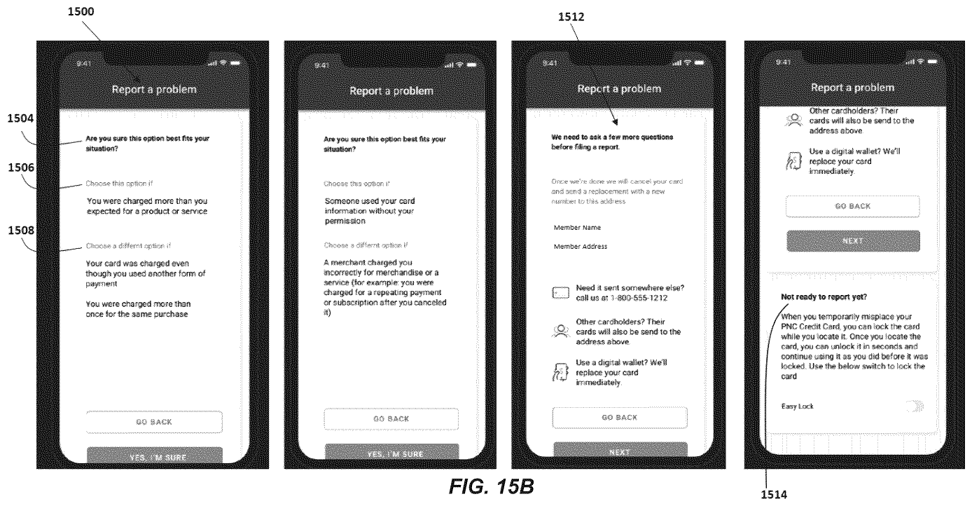

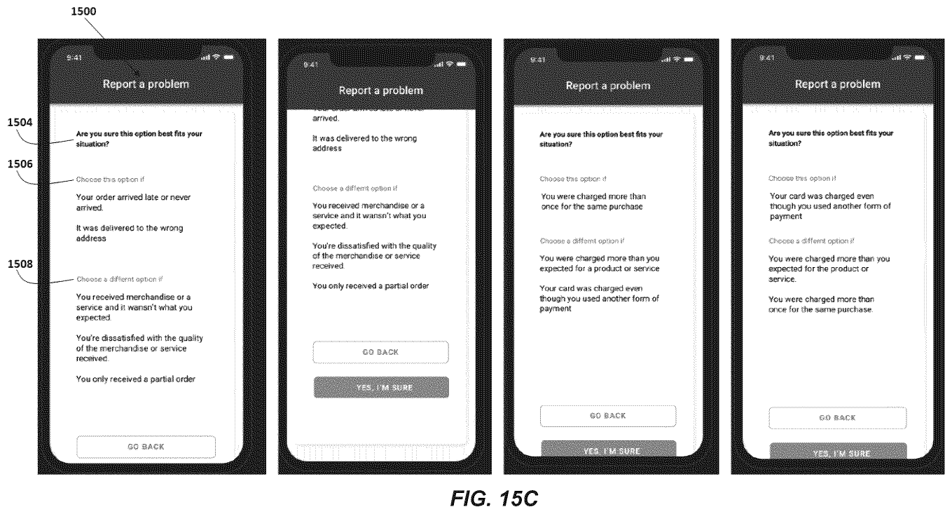

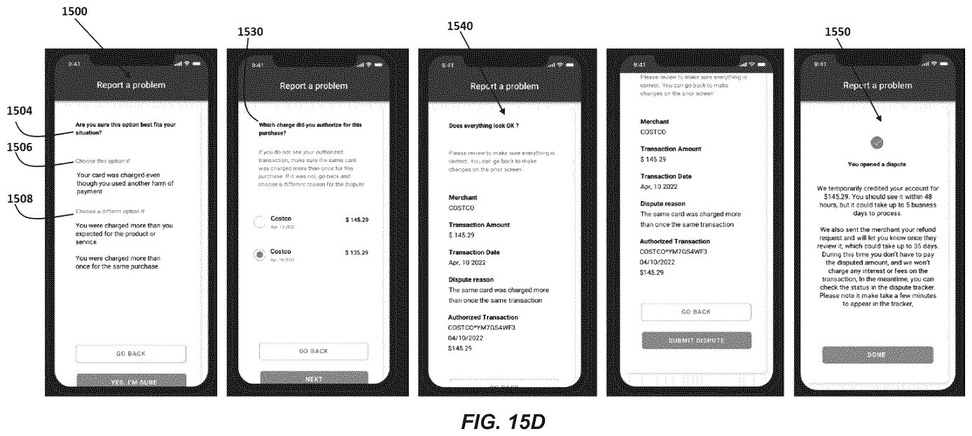

FIG. 15A is an illustration of a report a problem feature 1500. In some embodiments, the personalized banking application may include the report a problem feature 1500 that allows the user to report a problem with a transaction. In some embodiments, the report a problem feature 1500 may include a prompt 1502, displayed on the graphical use interface, asking the user what is wrong with a given transaction. The prompt 1502 may be followed by an instruction for the user to choose the from a list of given scenarios, the scenario that best describes the user's problem. In some embodiments, the list of given scenarios may include scenarios such as, the user returned or canceled a one-time purchase and has not received credit, the merchant was late or never provided the product or service, the user is dissatisfied with the quality of the product or service, the user was charged a higher amount than expected, the user's card was charged more than once for the same transaction, the user's card was charged even though the user used cash or a different card, or the user did not make a purchase. In some embodiments, the user may select a scenario from the list of given scenarios by interacting with the graphical user interface.

In some embodiments, once a user has selected a scenario from the list of given scenarios, a second prompt 1504 may appear asking the user to confirm that the selected scenario is the best fit for the user's problem. In some embodiments, the second prompt 1504 may be accompanied by an explanation of when the user should choose the selected option 1506 and an explanation of when the user should choose a different option 1508. In some embodiments, if the user has selected the scenario that the user returned or canceled a one-time purchase and has not received credit, the explanation of when the user should choose the selected option 1506 may say that the user should choose this option if the user canceled or returned a one-time purchase and has not received a refund. In some embodiments, if the user has selected the scenario that the user returned or canceled a one-time purchase and has not received credit, the explanation of when the user should choose the different option 1508 may say that the user should choose a different option if the user returned merchandise that is defective or not as the user expected.

In some embodiments, if the user has selected the option indicating that the user is dissatisfied with the quality of the product or service, the explanation of when the user should choose the selected option 1506 may say that the user should choose this option if the user received a merchandise or a service and it was not what the user expected, the user is dissatisfied with the quality of merchandise or service received, or the use only received a partial order. In some embodiments, if the user has selected the option indicating that the user is dissatisfied with the quality of the product or service, the explanation of when the user should choose the different option 1508 may say that the user should choose the different option 1508 if the order arrived late or never arrived or if the order was delivered to the wrong address.

FIG. 15B is an illustration of one embodiment of the report a problem feature 1500 of the personalized banking application. In some embodiments, if the user has selected the option indicating the user was charged a higher amount than expected, the explanation of when the user should choose the selected option 1506 may say that the user should choose this option if the user was charged more than expected for the product or service. In some embodiments, if the user has selected the option indicating the user was charged a higher amount than expected, the explanation of when the user should choose a different option 1508 may say that the user should choose a different option if the user's card was charged even though the user used another form of payment, or if the user was charged more than once for the same purchase.

In some embodiments, the report a problem feature may include a report summary page 1512. In some embodiments, the report a problem feature 1500 may include a not ready to report yet option 1514. In some embodiments, the report summary page 1512 may inform the user that more questions may be asked before filing the report. In some embodiments, the report summary page 1512 may inform the user that once all questions have been answered, the user will receive a new card delivered to the user's address. In some embodiments, the report summary page 1512 may include common card delivery answers. In some embodiments, the report summary page 1512 may inform users that they should call a number displayed on the graphical user interface if they would like the card delivered to an address other than the user's address. In some embodiments, the report summary page 1512 may inform the user that cards belonging to other cardholders will also be sent to the user's address. In some embodiments, the report summary page 1512 may inform the user that a digital card replacement can be made available immediately. In some embodiments, the not ready to report yet option 1514 may inform the user that the user's credit card can be temporarily locked using the personal banking application. In some embodiments, the not ready to report yet option may include an easy lock button that the user can use to lock their card.

FIG. 15C is a further illustration of an embodiment of the report a problem feature 1500 of the personalized banking application.

FIG. 15D is a further illustration of an embodiment of the report a problem feature 1500 of the personalized banking application. In some embodiments, the report a problem feature 1500 may include a charge identification option 1530, a final report review page 1540, and a report submission page 1550. In some embodiments, the charge identification option 1530 may present the user with one or more charges that were made to a card and asks the user to authenticate which charge was authorized. In some embodiments, the final report review page 1540 may include an overview of the report including the merchant name, the transaction amount, the transaction date, the dispute reason, and/or transaction identifying information from the transaction authenticated using the charge identification option 1530. In some embodiments, the report submission page 1550 may indicate that the report has been submitted and a dispute has been opened. In some embodiments, the report submission page 1550 may inform the user if the user has been temporarily credited for the disputed transaction amount and gives a timeframe for dispute resolution. In some embodiments, the report submission page 1550 may inform the user that the merchant has been sent a refund request and gives a time frame for the merchant response. In some embodiments, the report submission page 1550 informs the user that the dispute may be tracked via the track dispute feature.

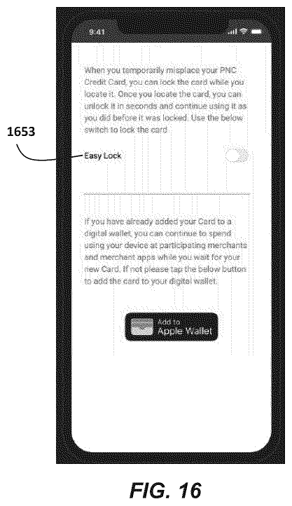

FIG. 16 is an illustration of the easy lock feature 1653 of the personalized banking application. In some embodiments, the easy lock feature 1653 may allow the user to lock a card that has been misplaced via the personalized banking application.

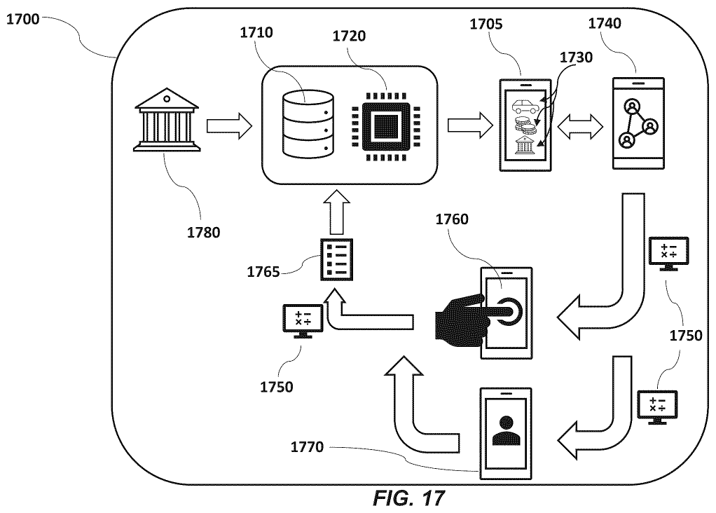

FIG. 17 is schematic representation of a system 1700 for automatically updating a home page 1705 of a digital application. In some embodiments, the digital application may be the personalized banking application. In some embodiments, the system 1700 for automatically updating a home page 1705 of a digital application may include a memory 1710, a processor 1720, a plurality of secondary applications 1730, at least one user input option 1740, a machine learning algorithm 1750, a set of user interactions 1760, a user profile 1770 and a set of historical data 1780.

As referred to herein, a “memory” may comprise any type of computer-readable storage medium. A computer-readable storage medium may store instructions for execution by at least one processor, such as processor 1720, including instructions for causing the processor to perform steps or stages consistent with an embodiment herein. Additionally, one or more computer-readable storage mediums may be utilized in implementing a computer-implemented method. The term “computer-readable storage medium” should be understood to include tangible items and exclude carrier waves and transient signals. Furthermore, memory 1710 may include one or more storage devices configured to store data for use by the system 1700. Memory 1710 may include, but is not limited to, a hard drive, a solid-state drive, a CD-ROM drive, a peripheral storage device (e.g., an external hard drive, a USB drive, etc.), a network drive, a cloud storage device, or any other storage device.

As referred to herein, a “processor” may be any type of computing device capable of executing instructions. A processor, such as processor 1720, may take the form of, but is not limited to, a microprocessor, embedded processor, or the like, or may be integrated in a system on a chip (SoC). Furthermore, according to some embodiments, processor may be from the family of processors manufactured by Intel®, AMD®, Qualcomm®, Apple®, NVIDIA®, or the like. The processor may also be based on the ARM architecture, a mobile processor, or a graphics processing unit, etc. In some embodiments, the memory 1710 may store instructions for automatically updating the home page 1705 of a digital application. In some embodiments, the processor 1720 may be configured to be executed the instructions for automatically updating the home page 1705 of a digital application.

In some embodiments, the stored instructions may be executed by the processor 1720 to display a plurality of secondary applications 1730 hosted on the home page 1705 of the digital application. In some embodiments, each of the plurality of secondary applications 1730 may include an at least one user input option 1740. In some embodiments, the at least one user input option 1740 may be a selectable button, icon, or interactive display located on the graphical user interface that the user identifies visually and then selects. In some embodiments, the at least one user input option 1740, as described herein, may be a combination of an audio user input option, a haptic user input option, a touch recognition user input option, and/or a facial recognition user input option.

In some embodiments, the processor 1720 may generate the user profile 1770 based on the set of user interactions 1760 with the at least one user input option 1740 and a set of historical information 1780.

In some embodiments, the processor 1720 may continuously monitor the digital application and updates the user profile 1770 based on the set of user interactions 1760 with the plurality of user input options 1740 and the set of historical information 1780. In some embodiments, the processor 1720 may generate, utilizing the machine learning algorithm 1750, an updated at least one user input option 1740 for each of the plurality of secondary applications 1730 based on the user profile 1770. In some embodiments, the processor 1720 may display the updated at least one user input option 1740 for each of the plurality of secondary applications 1730.

In some embodiments, the processor 1720 may assign, using the machine learning algorithm 1750, a score 1765 to each of the updated at least one user input options 1740 for each of the plurality of secondary applications 1730. In some embodiments, the score 1765 may be determined based on whether the user interacts with one or more of the updated at least one user input option 1740 for each of the plurality of secondary applications 1730. In some embodiments, the processor 1720 may update, using the machine learning algorithm 1750, the user profile 1770 based on the scores 1765. In some embodiments, the processor 1720 may continuously monitor the user profile 1770 using the machine learning algorithm 1750, to determine whether a further update to the updated at least one user input option 1740 is necessary based on changes to the user profile 1770.

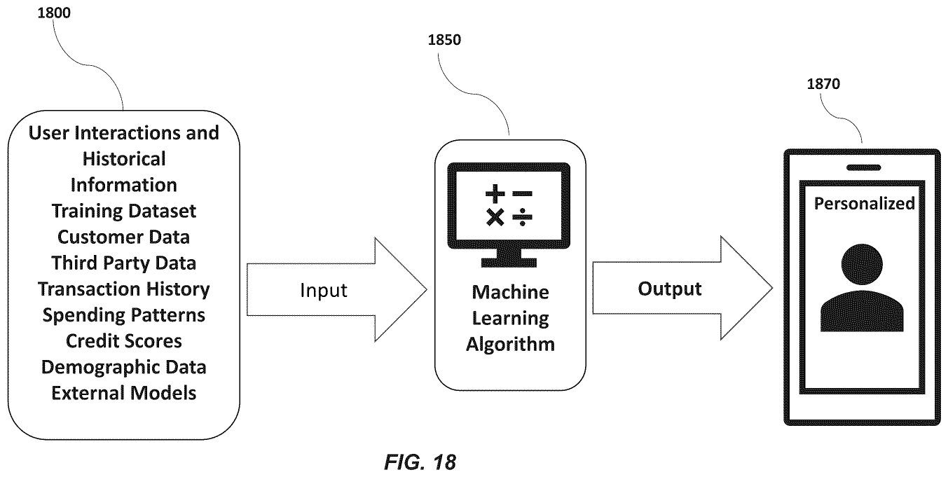

FIG. 18 is a schematic diagram illustrating one or more datasets 1800 used to train the machine learning algorithm 1850 to generate, update, and/or personalize the user profile 1870. In some embodiments, the machine learning algorithm 1850 may comprise one or more machine learning algorithms. In some embodiments, the one or more datasets 1800 may include a set of user interactions, a historical information, a training dataset, a customer data dataset, a third-party dataset, a transaction history dataset, a spending patterns dataset, a credit scores dataset, a demographic data dataset, and/or one or more external models. In some embodiments, the set of user interactions may comprise data corresponding to commonly used digital application features including but not limited to which features where used, the time the features were used, how long the features were used for, etc. In some embodiments, the historical information may include historical data about the user. In some embodiments, the transaction history dataset may include relevant information about past transactions made by the user such as what was transacted for, as well as the time, place and date of the transaction. In some embodiments, the spending patterns dataset may include relevant data about how past transactions relate to each other. In some embodiments, the credit scores dataset may include the user's past credit history. In some embodiments, the demographic data dataset may include demographic information about the user, and people associated with the user.

In some embodiments, the machine learning algorithm 1850 may learn patterns from the one or more datasets 1800 to make predictions or classifications. For instance, when training a fraud detection model, the transaction history dataset may be labeled with one or more labels indicating whether a transaction is fraudulent or not. Training the machine learning algorithm on the labeled transaction history dataset may increase the likelihood that the algorithm will correctly identify fraudulent transactions. In some embodiments, the machine learning algorithm 1850 may be trained for credit scoring on the one or more datasets including the customer data dataset, which includes information like income, credit limits, and repayment history. In some embodiments, the historical information may include a set of location-based information for transactions. In some embodiments, the machine learning algorithm 1850 may use the set of location-based information for transactions to generate a location-based rewards offer. In some embodiments, the historical information may comprise a set of time-based information for transactions. In some embodiments, the machine learning algorithm 1850 may use the set of location-based information for transactions to generate a location-based rewards offer. In some embodiments, the historical information may include a set of product-based information for transactions. In some embodiments, the machine learning algorithm 1850 may use the set of product-based information for transactions to generate a product-based rewards offer. In some embodiments, the machine learning algorithm may use the set of information related to the user vehicle to present the set of vehicle-related offers. In some embodiments, the set of vehicle-related offers may include the set of offers from FIG. 8C.

In some embodiments the customer data dataset may comprise transaction history, spending patterns, credit scores, and demographic data. In some embodiments, the machine learning algorithm 1850 may learn patterns from the customer data dataset to make predictions or classifications. For example, in one embodiment when training a fraud detection machine learning algorithm, the transaction history may be labeled to indicate whether a transaction is fraudulent or not. Similarly, in one embodiment, when training a credit scoring machine learning algorithm 1850, the customer data dataset may include customer information such as income, credit limits, and repayment history would be utilized to train the credit scoring machine learning algorithm 1850.

In some embodiments, the machine learning algorithm 1850 may be a semi-supervised machine learning model which collects data about user transaction (monetary, credit, non-monetary) that is added to the customer data dataset and builds the user profile 1870 based on the customer data dataset. The semi-supervised machine learning model may constantly learn from the user's behavior through the set of user interactions and the customer data dataset and applies boosting and deep learning machine learning algorithms to configure and update the user profile 1870.

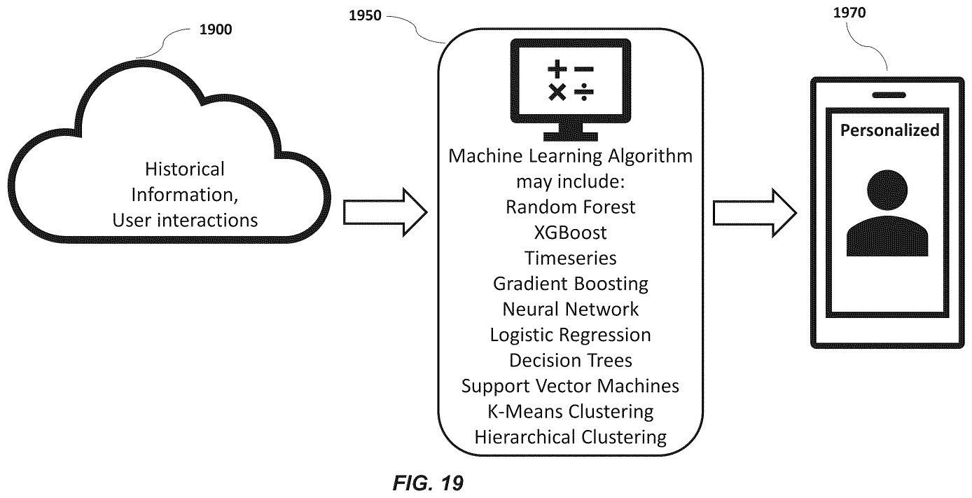

FIG. 19 is a schematic diagram representing the one or more machine learning algorithms that comprise a machine learning algorithm 1950. In some embodiments, data 1900 may be used to train the machine learning algorithm 1950. In some embodiments, the machine learning algorithms 1950 may include boosting algorithms, deep-learning algorithms, and other algorithms. In some embodiments, different machine learning algorithms 1950 may be used to execute different features of the system for automatically updating a home page of a digital application. In a non-limiting example, feature engineering based on data collection happens based on the datasets mentioned herein. In some embodiments, a correlation matrix and a principal component analysis may drive the feature engineering for the machine learning algorithm 1950.

In some embodiments of the machine learning algorithm 1950, a classification and regression model may use the one or more datasets, including the customer data dataset to determine both when and how to update a user profile 1970 and the probability customers will respond to the offers generated for the personalized banking application.

In some embodiments, the machine learning algorithm 1950 may be a pricing model. In some embodiments, the pricing model may be a heuristic model. In some embodiments, the features of the pricing model may be determined based on a random forest, an XGBoost, and/or a neural network machine learning algorithm. In some embodiments, the pricing model may include price elasticity. In some embodiments, the price elasticity may be calculated using off conjoint, and timeseries machine learning algorithms.

In some embodiments, the vehicle value feature may include a vehicle to vehicle-value ratio that may be determined using random forest and gradient boosting regressing machine learning algorithms. In some embodiments, the machine learning algorithm 1950 may be used to generate one or more portals. In some embodiments, the one or more portals may be derived based on the score. In some embodiments, the machine learning algorithm 1950 may be used to adjust credit or credit-based decisions. In some embodiments, the machine learning model used to adjust credit or credit-based decisions may be a logistic regression and/or a decision tree machine learning algorithm.

In some embodiments, the machine learning algorithm 1950 may assist in fraud detection and may be a Random Forest algorithm, a Gradient Boosting algorithm, and/or a Neural Network algorithm. In some embodiments, when assisting in fraud detection, the machine learning algorithm 1950 may be the Random Forrest algorithm which can efficiently handle imbalanced data by avoiding overfitting and identifying patterns indicative of fraud. In some embodiments, the machine learning algorithm 1950 may assist in credit scoring and may be a Logistic Regression algorithm, a Decision Tree algorithm, and/or a Support Vector Algorithm. In some embodiments, the machine learning algorithm 1950 may assist in customer segmentation and may be a K-Means Clustering algorithm and/or a Hierarchical Clustering algorithm.

In some embodiments, the machine learning algorithm 1950 may be engineered to execute tasks at increased speed. In some embodiments, one or more techniques may be used to increase the speed of the machine learning algorithm, including decreasing dataset size, feature extraction, data preprocessing, parallel processing, using real time data, and/or using batch datasets.

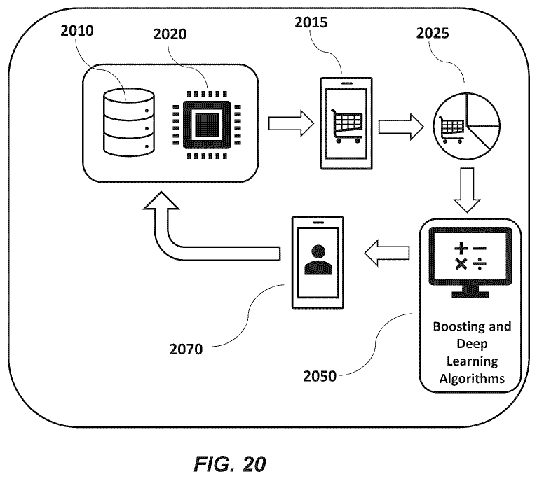

FIG. 20 is a schematic diagram of one embodiment of a system for updating a user profile 2070 of a digital application using a processor 2020 and a machine learning model 2050. In the embodiment represented in FIG. 20, the user may make a transaction 2015. The transaction 2015 may be recorded in the customer data dataset 2025 which may be saved in the memory 2010. The customer data dataset 2025 may be used to train the boosting and deep learning algorithms that comprise the machine learning algorithm 2050. The machine learning algorithm 2050, when commanded by the processor and using the customer dataset 2025, may update the user profile 2070. The process described in this paragraph may then be used to continuously update the user profile 2070.

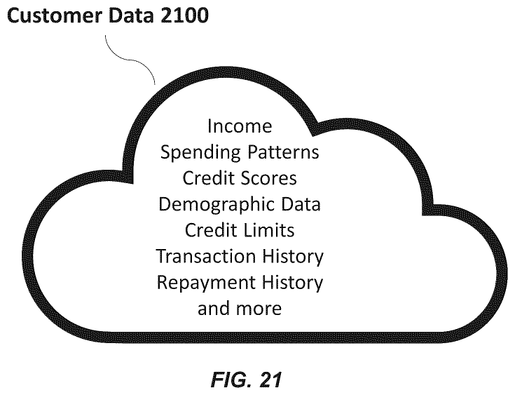

FIG. 21 is a schematic diagram depicting one or more embodiments of a customer data dataset 2100. In some embodiments, the customer data dataset 2100 may include one or more datasets related to the individual user, such as a user income dataset, a user spending patterns dataset, a user credit scores dataset, a user demographic data dataset, a user credit limits dataset, a user transaction history dataset, a user repayment history dataset, and other user datasets. In some embodiments the one or more datasets related to the individual user may include data that the user has provided. In some embodiments the one or more datasets related to the individual user may include data that has been gathered by the machine learning algorithm. In some embodiments, the one or more datasets related to the individual user may include data that has been supplied to the machine learning algorithm by one or more financial institutions. In some embodiments, the one or more datasets related to the individual user may include data that has been supplied to the machine learning algorithm by one or more third-party datasets. In some embodiments, the one or more datasets related to the individual user may be hybrid datasets including data that has been provided by the user, data that has been gathered by the machine learning algorithm, data that has been supplied to the machine learning algorithm by one or more financial institutions, and/or data that has been supplied to the machine learning algorithm by one or more third-party datasets. In some embodiments the data that has been gathered by the machine learning algorithm may be user transactions data, and/or user location data.

In some embodiments the user income dataset, the user spending patterns dataset, the user credit scores dataset, the user demographic data dataset, the user credit limits dataset, the user transaction history dataset, the user repayment history dataset, and the other user datasets may be used by the machine learning algorithm to update the user profile, to update the user homepage, and/or to generate personalized offers.

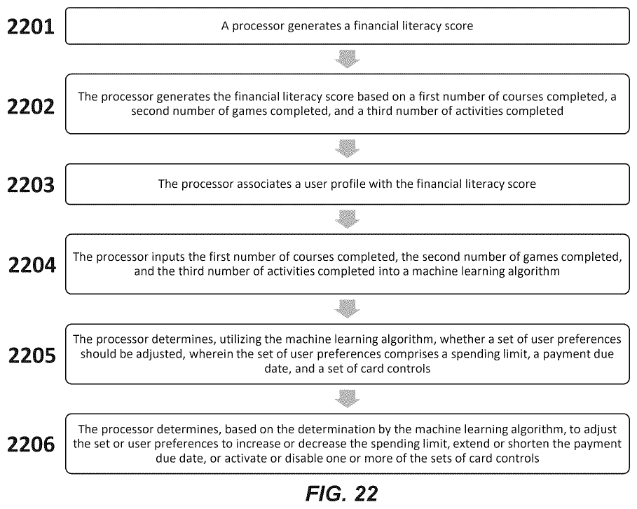

FIG. 22 is a flowchart representing steps that may be taken by a system for automatically updating the home page of the personalized banking application using the machine learning algorithm. In some embodiments, the system may include a step 2201 where a processor that generates a financial literacy score. In some embodiments, the system may include a step 2202 where the processor generates the financial literacy score based on a first number of courses completed, a second number of games completed, and a third number of activities completed. In some embodiments, the system may include a step 2203 where the processor associates a user profile with the financial literacy score. In some embodiments, the system may include a step 2204 where the processor inputs the first number of courses completed, the second number of games completed, and the third number of activities completed into a machine learning algorithm. In some embodiments, the system may include a step 2205 where the processor determines, utilizing the machine learning algorithm, whether a set of account preferences should be adjusted, wherein the set of account preferences comprises a spending limit, a payment due date, and a set of card controls. In some embodiments, the system may include a step 2206 where the processor determines, based on the determination by the machine learning algorithm, to adjust the set of account preferences to increase or decrease the spending limit, extend or shorten the payment due date, or activate or disable one or more of the sets of card controls.

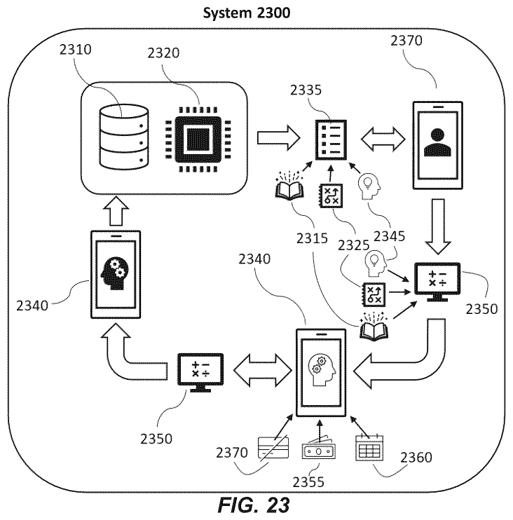

FIG. 23 is a schematic diagram depicting a system 2300 for automatically updating account preferences 2340 in a digital application using a machine learning algorithm 2350. In some embodiments the system for automatically adjusting account preferences 2300 may include at least one memory 2310 for storing instructions and at least one processor 2320 in communication with the at least one memory 2310. In some embodiments, the at least one processor 2320 may be configured to execute the stored instructions to generate a financial literacy score 2335. In some embodiments, the financial literacy score 2335 may be determined by a first number of courses completed 2315, a second number of games completed 2325, and a third number of activities completed 2345. In some embodiments, the processor 2320 may be configured to associate a user profile 2370 with the financial literacy score 2335. In some embodiments, the processor 2320 may be configured to input the first number of courses completed 2315, the second number of games completed 2325, and the third number of activities 2345 completed into the machine learning algorithm 2350. In some embodiments, the processor 2320 may be configured to determine, utilizing the machine learning algorithm 2350, whether a set of account preferences 2340 should be adjusted. In some embodiments, the set of account preferences 2340 may include a spending limit 2355, a payment due date 2360, and a set of card controls 2370. In some embodiments, the processor 2320 may be configured to, based on the determination by the machine learning algorithm 2350, adjust the set of account preferences to increase or decrease the spending limit 2355, extend or shorten the payment due date 2360, or activate or disable one or more of the set of card controls 2370. In some embodiments, the financial literacy score 2335 may be influenced by a depth of the first number of courses completed 2315. In some embodiments the second number of games completed 2325 may include simulations and gamification. In some embodiments, the third number of activities completed 2345 may include budgeting, planning, and investment simulators. In some embodiments, the machine learning algorithm 2350 may be used to create personalized learning curriculums that can be used to personalize the courses 2315, the games 2325, and the activities 2345.

In some embodiments, the user profile 2370 may include a spending history. In some embodiments, the spending history may include a set of location-based information for transactions. In some embodiments, the machine learning algorithm 2350 may use the set of location-based information for transactions to generate a location-based rewards offer.

In some embodiments, the spending history includes a set of time-based information for transactions. In some embodiments the machine learning algorithm 2350 may use the set of time-based information for transactions to generate a time-based rewards offer. In some embodiments, the spending history may include a set of product-based information for transactions. In some embodiments, the machine learning algorithm 2350 may use the set of product-based information for transactions to generate a product-based rewards offer.

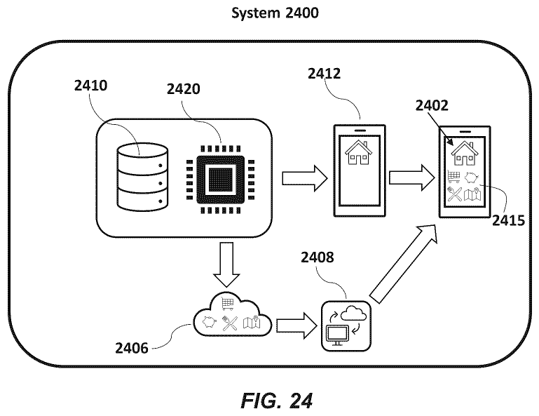

FIG. 24 is a schematic diagram illustrating a system 2400 for integrating third party application data into a digital application. In some embodiments, the system 2400 for integrating third party application data into a digital application may include at least one memory 2410 for storing instructions and at least one processor 2420 in communication with the at least one memory 2410. In some embodiments, the at least one processor 2420 may be configured to display a plurality of micro-applications 2415 hosted on a home page 2402 of the digital application. In some embodiments, each of the plurality of micro-applications 2415 may comprise a front-end interface 2412 that receives and displays information. In some embodiments, the front-end interface may include a graphical user interface. In some embodiments, the graphical user interface may receive information from a user and display information to the user. In some embodiments, the at least one processor 2420 may be configured to send a set of third-party hosted application information 2406 to the digital application through a set of application programming interfaces 2408. In some embodiments, the at least one processor 2420 may be configured to convert the set of third-party hosted application information 2406, using the set of application programming interfaces 2408, into information suitable for display on the home page 2402 of the digital application.

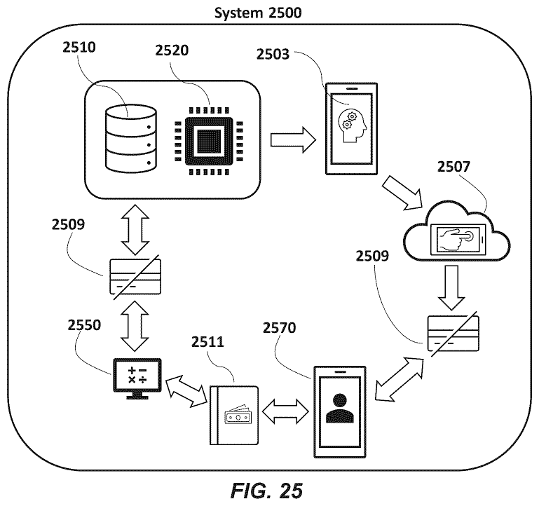

FIG. 25 is a schematic diagram illustrating a system 2500 for automatically updating account preferences 2503 in a digital application using a machine learning algorithm 2550. In some embodiments, the system 2500 for automatically updating account preferences 2503 in a digital application may include at least one memory 2510 for storing instructions and at least one processor 2520 in communication with the at least one memory 2510. In some embodiments, the at least one processor 2520 may be configured to execute the stored instructions to generate, based on a set of user inputs 2507, a set of card control preferences 2509. In some embodiments, the set of card control preferences 2509 may include a set of location-based controls, a set of threshold amount controls, a set of merchant type controls, and a set of transaction type controls. In some embodiments, the at least one processor 2520 may be configured to execute instructions to associate a user profile 2570 with the set of card control preferences 2509. In some embodiments, the at least one processor 2520 may be configured to input a transaction history 2511 into the machine learning algorithm 2550, the transaction history including geolocation information, card use information, and merchant information. In some embodiments, the at least one processor 2520 may be configured to execute instruction to determine using the machine learning algorithm 2550, whether the set of card control preferences 2509 should be adjusted based on the transaction history 2511. In some embodiments, the at least one processor 2520 may be configured to execute instructions to automatically adjust the set of card control preferences 2509 based on the determination, thus, account preferences 2503 are automatically updated.

In some embodiments of the system 2500, the machine learning algorithm 2550 may use the geolocation information to generate an in-store rewards offer. In some embodiments of the system 2500, the machine learning algorithm 2550 may use the geolocation information to generate a location-specific rewards offer. In some embodiments of the system 2500, the machine learning algorithm 2550 may use the merchant information to generate a merchant-specific rewards offer. In some embodiments of the system 2500 the set of card control preferences 2509 further may include a credit card-lock. In some embodiments of the system 2500, the credit card-lock may lock a physical credit card. In some embodiments of the system 2500 the credit card-lock may not lock a virtual credit card.

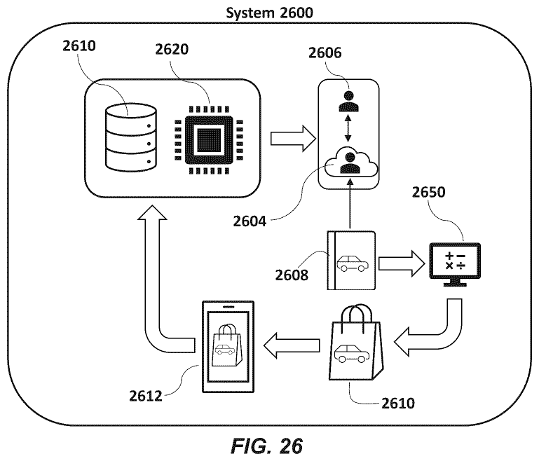

FIG. 26 is a schematic diagram illustrating a system 2600 for automatically generating offers in a digital application using a machine learning algorithm 2650. In some embodiments, the system 2600 may include at least one memory 2610 for storing instructions and at least one processor 2620 in communication with the at least one memory 2610. In some embodiments, the at least one processor 2620 may execute the stored instructions to associate a user account 2604 with a user 2606. In some embodiments, the user account 2604 may include a set of vehicle information 2608 including at least one of a set of mileage information, a loan balance, a vehicle value, a vehicle age, a vehicle make, a vehicle model, a vehicle year, a set of vehicle location information, and a loan term. In some embodiments, the processor 2620 may execute the stored instructions to input the set of vehicle information 2608 into the machine learning algorithm 2650. In some embodiments, the processor 2620 may execute the stored instructions to determine, utilizing the machine learning algorithm 2650, a set of offers 2610 for the user 2606 based on the set of vehicle information 2608. In some embodiments, the set of offers 2610 may include at least one of an offer on vehicle maintenance, an offer on vehicle insurance, an offer on vehicle refinance, and a set of offers based on vehicle location. In some embodiments, the processor 2620 may execute the stored instructions to present one or more of the offers from the set of offers 2610 on a display of a user device 2612.

In some embodiments of the system 2600, the offer on vehicle maintenance may be based on the set of mileage information. In some embodiments of the system 2600, the offer on vehicle insurance may be based on the vehicle type and a user credit score. In some embodiments of the system 2600, the machine learning algorithm 2650 may generate a pricing model based, at least in part, on a user credit score. In some embodiments of the system 2600, the machine learning algorithm 2650 may use the set of vehicle location information to generate a location heat map. In some embodiments of the system 2600, the machine learning algorithm 2650 may use the set of vehicle information 2608 to generate a vehicle loan to vehicle value ratio.

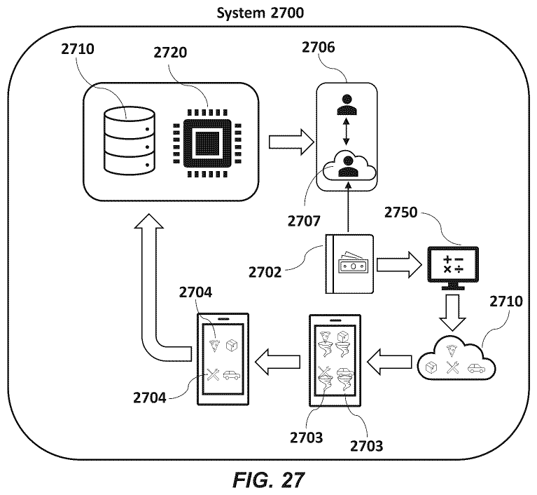

FIG. 27 is a schematic diagram illustrating a system 2700 for automatically generating portals 2703 to one or more third-party applications 2704 using a machine learning algorithm 2750. In some embodiments, the system 2700 may comprise at least one memory 2710 for storing instructions and at least one processor 2720 in communication with the at least one memory 2710. In some embodiments, the at least one processor 2720 may execute the stored instructions to associate a user account 2707 with a user 2706. In some embodiments, the user account 2707 may include a set of payment information 2702 In some embodiments, the set of payment information 2702 may automatically update when a new transaction occurs. In some embodiments, the at least one processor 2720 may execute the stored instructions to input the set of payment information 2702 into the machine learning algorithm 2750. In some embodiments, the at least one processor 2720 may execute the stored instructions to determine, using the machine learning algorithm 2750, a set of preferred service providers and sellers 2711 based on the set of payment information 2702. In some embodiments, the at least one processor 2720 may execute the stored instructions to generate a set of portals 2703 to the set of preferred service providers and sellers 2711. In some embodiments, the at least one processor 2720 may execute the stored instructions to present the set of portals 2703 on the display of a mobile device. In some embodiments, the at least one processor 2720 may execute the stored instructions to receive a selection of one of the set of portals 2703 and automatically redirect the user to the third-party application 2704 corresponding to a preferred service provider or seller within the set of preferred service providers or sellers 2711, wherein the set of portals 2703 may automatically redirect the user to the third-party application 2704 corresponding to a preferred service provider or seller within the set of preferred service providers or sellers 2711. In some embodiments of the system 2700, the set of portals 2703 may enable payment via a buy now pay later feature within the digital application.

In some embodiments, one or more third-party datasets may be integrated into the digital application using the machine learning algorithm. In some embodiments, the one or more third-party datasets may include credit bureau datasets, public records datasets, social media datasets, and or other datasets. In some embodiments, the one or more third-party datasets may be integrated with one or more customer datasets.

In some embodiments the one or more third-party datasets may be in different formats and structures. In some embodiments, one or more data aggregation techniques may be used to combine, clean, and format the one or more third-party datasets so they are compatible with the machine learning algorithm 2750. In some embodiments, the machine learning algorithm 2750 may make Application Programming Interface (API) requests to one or more third-party providers to fetch one or more relevant third-party datasets in real-time.

In some embodiments, the machine learning algorithm 2750 may add information from one or more third-party datasets including recent financial transaction information, social media activity, and/or credit history to one or more existing customer datasets to enrich the one or more customer datasets with valuable information. In some embodiments, the one or more third-party datasets may include extractable features that can be used as inputs for the machine learning algorithm 2750. For example, in some embodiments, data from user social media activity may provide insights into user spending habits or user lifestyle preferences. In some embodiments, the one or more third-party data providers may offer pre-trained machine learning models that can be integrated into the machine learning algorithm 2750, allowing the machine learning algorithm 2750 to benefit from third-party data provider expertise. In some embodiments, the machine learning algorithm 2750 is designed to periodically update with fresh third-party data to ensure that the machine learning algorithm 2750 remains accurate and up to date. Integration of third-party data into the machine learning algorithm 2750 should always adhere to data privacy regulations and user consent requirements.

1-24. (canceled)

25. A system comprising:
at least one memory for storing instructions; and
at least one processor in communication with the at least one memory, the at least one processor configured to execute the stored instructions to:
associate a user account with a user, the user account including a set of vehicle information including at least one of a set of mileage information, a loan balance, a vehicle value, a vehicle age, a vehicle make, a vehicle model, a vehicle year, a set of vehicle location information, or a loan term;
input the set of vehicle information into a machine learning algorithm;
determine, utilizing the machine learning algorithm, a set of offers for the user based on the set of vehicle information, wherein the set of offers includes at least one of a vehicle maintenance offer chosen from a set of vehicle maintenance offers, a vehicle insurance offer chosen from a set of vehicle insurance offers, a vehicle refinance offer chosen from a set of vehicle refinance offers, or a sales offer chosen from a set of sales offers based on vehicle location; and
send the set of offers for display to a user interface configured for display on a user device associated with the user, the user interface configured to collate and rank the set of offers based on a desirability metric generated based on a metadata variable associated with the user account.

26. The system of claim 25, wherein the vehicle maintenance offer is based on the set of mileage information.

27. The system of claim 25, wherein the vehicle insurance offer is based on the vehicle type and a user credit score.

28. The system of claim 25, wherein the machine learning algorithm is configured to generate a pricing model based, at least on a user credit score.

29. The system of claim 25, wherein the machine learning algorithm is configured to use the set of vehicle location information to generate a location heat map.

30. The system of claim 25, wherein the machine learning algorithm is configured to use the set of vehicle information to generate a vehicle loan to vehicle value ratio.

31-32. (canceled)

33. A method comprising:
associating a user account with a user, the user account including a set of vehicle information including at least one of a set of mileage information, a loan balance, a vehicle value, a vehicle age, a vehicle make, a vehicle model, a vehicle year, a set of vehicle location information, or a loan term;
inputting the set of vehicle information into a machine learning algorithm;
determining, utilizing the machine learning algorithm, a set of offers for the user based on the set of vehicle information, wherein the set of offers includes at least one of a vehicle maintenance offer chosen from a set of vehicle maintenance offers, a vehicle insurance offer chosen from a set of vehicle insurance offers, a vehicle refinance offer chosen from a set of vehicle refinance offers, or a sales offer chosen from a set of sales offers based on vehicle location; and
sending the set of offers for display to a user interface configured for display on a user device associated with a user, the user interface configured to collate and rank the set of offers based on a desirability metric generated based on a metadata variable associated with the user account.

34. The method of claim 33, wherein the vehicle maintenance offer is based on the set of mileage information.

35. The method of claim 33, wherein the vehicle insurance offer is based on the vehicle type and a user credit score.

36. The method of claim 33, wherein the machine learning algorithm is configured to generate a pricing model based, at least on a user credit score.

37. The method of claim 33, wherein the machine learning algorithm is configured to use the set of vehicle location information to generate a location heat map.

38. The method of claim 33, wherein the machine learning algorithm is configured to use the set of vehicle information to generate a vehicle loan to vehicle value ratio.

39. A non-transitory computer-readable medium storing instructions that, when executed by one or more processors, cause the one or more processors to perform operations comprising:
associating a user account with a user, the user account including a set of vehicle information including at least one of a set of mileage information, a loan balance, a vehicle value, a vehicle age, a vehicle make, a vehicle model, a vehicle year, a set of vehicle location information, or a loan term;
inputting the set of vehicle information into a machine learning algorithm;
determining, utilizing the machine learning algorithm, a set of offers for the user based on the set of vehicle information, wherein the set of offers includes at least one of a vehicle maintenance offer chosen from a set of vehicle maintenance offers, a vehicle insurance offer chosen from a set of vehicle insurance offers, a vehicle refinance offer chosen from a set of vehicle refinance offers, or a sales offer chosen from a set of sales offers based on vehicle location; and
sending the set of offers for display to a user interface configured for display on a user device associated with a user, the user interface configured to collate and rank the set of offers based on a desirability metric generated based on a metadata variable associated with the user account.

40. The non-transitory computer-readable medium of claim 39, wherein the vehicle maintenance offer is based on the set of mileage information.

41. The non-transitory computer-readable medium of claim 39, wherein the vehicle insurance offer is based on the vehicle type and a user credit score.

42. The non-transitory computer-readable medium of claim 39, wherein the machine learning algorithm is configured to generate a pricing model based, at least on a user credit score.

43. The non-transitory computer-readable medium of claim 39, wherein the machine learning algorithm is configured to use the set of vehicle location information to generate a location heat map.

44. The non-transitory computer-readable medium of claim 39, wherein the machine learning algorithm is configured to use the set of vehicle information to generate a vehicle loan to vehicle value ratio.
